(19) United States
(12) Patent Application Publication
(10) Pub. No.: US 2012/0194796 A1
(43) Pub. Date: Aug. 2, 2012

(54) LIGHT QUANTITY ADJUSTMENT APPARATUS LENS UNIT AND OPTICAL APPARATUS PROVIDED WITH THE SAME

(75) Inventors: Katsura NAKAJIMA, Yamanashi-ken (JP); Naoto MOCHIZUKI, Yamanashi-ken (JP); Akira HAKOZAKI, Yamanashi-ken (JP)

(73) Assignee: NISCA CORPORATION, Yamanashi-ken (JP)

(21) Appl. No.: 13/357,793

(22) Filed: Jan. 25, 2012

(30) Foreign Application Priority Data
Jan. 31, 2011 (JP) 2011-018513
Feb. 28, 2011 (JP) 2011-041831

(51) Int. Cl. G03B 27/72; G02B 3/00

(52) U.S. Cl. 355/71; 359/642

(57) ABSTRACT

This light quantity adjustment apparatus is provided with a pair of first and second boards each having, an exposure aperture, and a plurality of diaphragm blades supported between the pair of broads to be openable and closable to adjust a quantity of light passing through the exposure aperture, and each of the diaphragm blades is comprised of a blade substrate in which are formed a base end portion positioned outside the exposure aperture, and a blade portion that moves forward and backward with respect to the exposure aperture to form a diaphragm aperture, and an auxiliary substrate, having a joint surface to be joined to the base end portion, in which are formed a first shaft portion penetrating the base end portion from the joint surface, and a second shaft portion provided to stand on the side opposite to the joint surface.

### TECHNICAL FIELD

The present invention relates to a light quantity adjustment apparatus that is incorporated into an optical apparatus including image pickup apparatuses such as a video camera and still camera, projection apparatuses such as a projector, etc. and that adjusts a quantity of light such as a shooting light quantity and projection light quantity.

### BACKGROUND ART

Generally, this type of light quantity adjustment apparatus is known as an apparatus in which a board having an exposure aperture is disposed in a shooting light path (or projection light path), and a plurality of light quantity adjustment blades is disposed at equal intervals around the exposure aperture in the board to be openable and closable so as to make the exposure aperture a large diameter or a small diameter, and thereby adjusts a quantity of light.

For example, Japanese Patent Application Publication No. 2008-203576 discloses an iris diaphragm apparatus in which a plurality of blades is disposed around an exposure aperture formed in a board, and opens and closes the light-path diameter from a small diameter to a large diameter in similar shapes. It is known that such a diaphragm apparatus has the feature of adjusting a quantity of light in multi-stage with diameters close to a circular shape using a plurality of blades.

The Publication discloses an open/close mechanism in which a plurality of diaphragm blades is disposed in the shape of scales around the exposure aperture between a pair of ring-shaped front and back boards in the optical axis direction having the exposure aperture at the center, and a driving unit provided on one of the boards opens and closes the plurality of diaphragm blades concurrently.

More specifically, as shown in FIGS. 15 and 16, in each of seven diaphragm blades 104 are formed a blade portion 104a and base end portion 104b by resin integral forming. On the front side and back side of the base end portion 104b, a first shaft portion 104c and second shaft portion 104d, axially supported by a pair of ring-shaped boards 100, 110, are integrally formed by resin forming. The first shaft portion 104c is axially supported in a shaft hole 110a provided in the ring-shaped board 110, and is capable of shifting around the exposure aperture by rotation of the ring-shaped board 110, and the second shaft portion 104d is guide-supported to be slidable along a slit guide 100a provided in the ring-shaped board 100. Then, each diaphragm blade 104 concurrently operates, opens and closes the exposure aperture from a small diameter to a large diameter in similar shapes, and adjusts a quantity of light.

Further, Japanese Patent Application Publication No. 2009-274217 discloses another formation method of a diaphragm blade usable in the open/close mechanism similar to the mechanism in Japanese Patent Application Publication No. 2008-203576.

The diaphragm blade is first die-cut in the shape of a blade formed of a blade portion 105 and base end portion 105b by pressing a thin sheet material that is a blade substrate, by a manufacturing method using the laser welding technique, as shown in FIG. 17.

Then, shaft portions 105c, 105d corresponding to the above-mentioned first shaft portion 104c and second shaft portion 104d are butted to the die-cut blade, and welded by applying a laser to the joint portions 105f, 105g. In addition, to perform laser welding, the die-cut blade is black to melt by laser irradiation heat, and color and material to allow the laser to pass through are selected for the shaft portions 105c, 105d.

### DISCLOSURE OF INVENTION

### Problems to be Solved by the Invention

Then, first, in the case of integrally forming the blade portion 104a, base end portion 104b and first and second shaft portions 104c and 104d of the diaphragm blade 104 by resin processing as described in Japanese Patent Application Publication No. 2008-203576, as shown in FIG. 16 described above, a material thickness t1 of the blade portion 104a undergoes limitations by conditions of resin forming, is limited to almost 0.1 mm, and cannot be thinned to a material thickness t0 of about 0.05 mm of the blade sheet material to die-cut as shown in Japanese Patent Application Publication No. 2009-274217.

As a result, there is the problem that the bow amount of the blade portion 104a of the diaphragm blade 104 is too small, the blades overlap one another when the exposure aperture is reduced to a small diameter, and adhere to one another by the blade portion 104a being forcibly warped, and that such a malfunction tends to occur that it is not possible to smoothly open and close.

Meanwhile, as described in Japanese Patent Application Publication No. 2009-274217, in the case of die-cutting and forming a thin sheet material (with a material thickness of about 0.05 mm) as a blade substrate of the diaphragm blade 105 in the shape of a blade formed of the blade portion 105a and the base end portion 105b by pressing, and welding the shaft portions 105c, 105d with a laser, it is possible to thin the material thickness t0 of the blade portion 105a of the diaphragm blade 105 to about 0.05 mm, a sufficient bow amount is ease to obtain, it is possible to control the friction load acting on between blades to within small values even in the state in which the blades overlap one another and warp in the state of the small diameter, as compared with the case of Japanese Unexamined Patent Publication No. 2008-203576, the blades are hard to adhere to one another, and the malfunction is significantly improved.

However, in the diaphragm blade 105 made by this laser welding, the following problem newly occurs. First, the blade portions 105a overlap one another in the state of the small diameter, loads are imposed on the joint portions 105f, 105g between the base end portion 105b and the shaft portions 105c, 105d when the blade portion 105a warps up, and the laser welding portions are easy to peel.

Further, although the above-mentioned inoperative does not occur, as shown in FIG. 18A, when the shaft portions 105c, 105d are laser-welded to the base end portion 105b, the shaft portions 105c, 105d tend to incline at inclined angles X1, X2 with respect to the plane of the base end portion 105b due to fluctuations in welding, the distance between the shaft portions 105c, 105d tends to be wider or smaller than the reference distance L0 therebetween, as a result the open/close angle of each diaphragm blade varies, the diaphragm aperture shape becomes distorted, and diaphragm performance sometimes thereby deteriorates.

Furthermore, by using the thin sheet material as the blade substrate, the base end portion 105b itself supporting the shaft portion 105d is also thin, tends to bow, and as shown in FIG. 18B, bows by the weight of the shaft portion 105d, as a result the front end of the shaft portion 105d comes into contact with the slit surface of the slit groove hole 100a of the board 100 more than necessary, and the malfunction is easy to occur.

The present invention was made in view of the aforementioned problems, and it is an object of the invention to provide a light quantity adjustment apparatus for enabling smooth open/close action of diaphragm blades without causing the problems such as the malfunction and inoperative as described above.

### Means for Solving the Problem

To attain the aforementioned object, a light quantity adjustment apparatus of the invention is provided with a pair of first and second boards each having an exposure aperture, and a plurality of diaphragm blades supported between the pair of broads to be openable and closable to adjust a quantity of light passing through the exposure aperture, and each of the diaphragm blades is comprised of a blade substrate in which are formed a base end portion positioned outside the exposure aperture, and a blade portion that moves forward and backward with respect to the exposure aperture to form a diaphragm aperture, and an auxiliary substrate, having a joint surface to be joined to the base end portion, in which are formed a first shaft portion penetrating the base end portion from the joint surface, and a second shaft portion provided to stand on the side opposite to the joint surface.

Further, a light quantity adjustment apparatus of the invention as described in claim 2 is provided with a pair of first and second boards each having an exposure aperture, and a plurality of diaphragm blades which are supported between the pair of broads to openable and closable, are sequentially overlapped at predetermined intervals around the exposure aperture to form the diaphragm, and adjust a quantity of light passing through the exposure aperture, each of the diaphragm blades is comprised of a blade substrate in which are formed a base end portion positioned outside the exposure aperture, and a blade portion that moves forward and backward with respect to the exposure aperture and that is curved in forming a diaphragm aperture, and an auxiliary substrate, having a joint surface to be joined to the base end portion, in which are formed a first shaft portion penetrating the base end portion from the joint surface, and a second shaft portion provided to stand on the side opposite to the joint surface, and the auxiliary substrate is bonded to the base end portion on the side on which the blade portion of the blade substrate is curved in forming the diaphragm aperture.

Furthermore, a light quantity adjustment apparatus of the invention as described in claim 3 is provided with a pair of boards each having an exposure aperture opposed to each other at a predetermined distance, and a plurality of diaphragm blades supported between the pair of boards to be openable and closable to adjust a quantity of light passing through the exposure aperture, each of the diaphragm blades is comprised of a blade substrate comprised of a base end portion, positioned outside the exposure aperture, in which are formed at least two, first and second through holes, and a blade portion that moves forward and backward with respect to the exposure aperture to form a diaphragm aperture, and first and second auxiliary substrates to sandwich the base end portion of the blade substrate, the first auxiliary substrate has a first shaft portion, penetrating the first through hole of the base end portion, supported on one of the pair of boards, the second auxiliary substrate has a second shaft portion, penetrating the second through hole of the base end portion, supported on the other one of the pair of boards, and the shaft length of the first shaft portion and the second shaft portion is set to be longer than the distance between the pair of boards.

Still Furthermore, a light quantity adjustment apparatus of the invention as described in claim 4 is provided with a pair of boards each having an exposure aperture opposed to each other at a predetermined distance, and a plurality of diaphragm blades supported between the pair of boards to be openable and closable to adjust a quantity of light passing through the exposure aperture, each of the diaphragm blades is comprised of a blade substrate comprised of a base end portion, positioned outside the exposure aperture, in which are formed at least two, first and second through holes, and a blade portion that moves forward and backward with respect to the exposure aperture to form a diaphragm aperture, and first and second auxiliary substrates to sandwich the base end portion of the blade substrate, the first auxiliary substrate has a first shaft portion, penetrating the first through hole of the base end portion, supported on one of the pair of boards, and a first shaft hole such that a second shaft portion of the second auxiliary substrate penetrates the second through hole of the base end portion, the second auxiliary substrate has the second shaft portion, penetrating the second through hole of the base end portion, supported on the other one of the pair of boards, and a second shaft hole such that the first shaft portion of the first auxiliary substrate penetrates the first through hole of the base end portion, and the shaft length of the first shaft portion and the second shaft portion is set to be longer than the distance between the pair of boards.

Moreover, a light quantity adjustment apparatus of the invention as described in claim 5 is provided with a pair of first and second boards each having an exposure aperture, and a plurality of diaphragm blades between the pair of broads to adjust a quantity of light pas sing through the exposure aperture, the plurality of diaphragm blades is successively piled and arranged at equal intervals around the exposure aperture on one board of the pair of boards in which among three mutually adjacent blades one blade adjacent to the center blade is positioned on the lower side and the other adjacent blade is positioned on the upper side, each of the diaphragm blades is comprised of a blade substrate in which are formed a base end portion positioned outside the exposure aperture, and a blade portion that moves forward and backward with respect to the exposure aperture to form a diaphragm aperture, and an auxiliary substrate, having a joint surface to be joined to the base end portion, in which are formed a first shaft portion penetrating the base end portion from the joint surface, and a second shaft portion provided to stand on the side opposite to the joint surface, the auxiliary substrate is disposed in the blade substrate on the side opposed to the other board of the pair of boards, and it is configured that one board of the pair of boards is a driving ring that opens and closes the plurality of diaphragm blades, a shaft hole that supports the first shaft portion of the auxiliary substrate is formed in the driving ring, the other board of the pair of boards is a base plate to set the exposure aperture that is a full aperture, and that a slit groove that guides the second shaft portion of the auxiliary substrate is formed in the base plate.

Further, in a light quantity adjustment apparatus of the invention as descried in claim 6, the plurality of diaphragm blades constituting claims 1 to 4 as described above is successively piled and arranged at equal intervals around the exposure aperture on one board of the pair of boards in which among three mutually adjacent blades one blade adjacent to the center blade is positioned on the lower side and the other adjacent blade is positioned on the upper side, and in each of the diaphragm blades, the auxiliary substrate is disposed in the blade substrate on the side opposed to the other board of the pair of boards.

Furthermore, in a light quantity adjustment apparatus of the invention as described in claim 7, one board of the pair of boards constituting claim 6 as described above is a driving ring that opens and closes the plurality of diaphragm blades, a shaft hole that supports the first shaft portion of the auxiliary substrate is formed in the driving ring, the other board of the pair of boards is a base plate to set the exposure aperture that is a full aperture, and a slit groove that guides the second shaft portion of the auxiliary substrate is formed in the base plate.

Moreover, a lens unit of the invention as described in claim 8 is a lens unit provided with a taking lens, and a light quantity adjustment apparatus that adjusts a quantity of light passing through the taking lens, where the light quantity adjustment apparatus is provided with the light quantity adjustment apparatus as descried in any one of claims 1 to 5 as described above. Then, an optical apparatus of the invention as described in claim 9 is provided with a lens unit having a taking lens, and a light quantity adjustment apparatus that adjusts a quantity of light passing through the taking lens, and light receiving means for receiving light of the quantity of light that is adjusted by the light quantity adjustment apparatus and that passes through the taking lens, where the lens unit is the lens unit as described in claim 8.

Advantageous Effect of the Invention

In the light quantity adjustment apparatus as described in claim 1 of the invention, the diaphragm blade is comprised of two components, a blade substrate in which are formed a base end portion positioned outside the exposure aperture, and a blade portion that moves forward and backward with respect to the exposure aperture to form a diaphragm aperture, and an auxiliary substrate, having a joint surface to be joined to the base end portion, in which are formed a first shaft portion penetrating the base end portion from the joint surface, and a second shaft portion provided to stand on the side opposite to the joint surface, the base end portion requiring the thickness is reinforced with the auxiliary substrate, it is thereby possible to thin the base end portion itself constituting the blade substrate, the blade substrate can be formed by die-cutting a thin sheet material, as a result it is possible to decrease the thickness of the blade portion of the blade substrate formed of the thin sheet material as compared with the case of resin forming, the blade portion can warp easily even in the state in which the blades overlap one another in reducing the exposure aperture to a small diameter, the blades thereby do not adhere to one another and can be opened and closed smoothly, and the apparatus has the effect for enabling the occurrence of the malfunction and inoperative to be reduced.

In the light quantity adjustment apparatus as described in claim 2 of the invention, the auxiliary substrate is bonded to the base end portion on the side on which the blade portion of the blade substrate is curved in forming the diaphragm aperture, the front end of the blade portion of the blade thereby warps by elastic deformation by overlapping of the blades in reducing the exposure aperture to a small diameter, the blade substrate is thus curved in the direction for enveloping the auxiliary substrate, the force in the direction for peeling from each other does not act on the bonding portion between the blade substrate and the auxiliary substrate, the substrates are hard to peel, and the apparatus has the effect for enabling the occurrence of the inoperative to be reduced.

In the light quantity adjustment apparatus as described in claim 3 of the invention, one board of the pair of boards that support the plurality of diaphragm blades to be openable and closable is the driving ring that opens and closes the plurality of diaphragm blades, and the shaft hole that supports the first shaft portion of the auxiliary board is formed in the driving ring. Meanwhile, the other board of the pair of boards is the base plate to set the exposure aperture that is a full aperture, and the slit groove that guides the second shaft portion of the auxiliary substrate is formed in the base plate. Therefore, by successively piling in the shape of scales while inserting the first shaft portion of the diaphragm blade in the shaft hole of the driving ring, it is possible to arrange a plurality of diaphragm blades at equal intervals around the exposure aperture formed in the driving ring with ease and reliability, the second shaft portion of the diaphragm blade is inserted in the slit groove of the base plate while covering the base plate from above in this state, it is thus possible to complete the base assembly of the diaphragm unit, and the apparatus has the effect that the assembly is ease and that productivity is improved.

In the light quantity adjustment apparatus as described in claim 4 of the invention, it is only essential to simply fit the first and second shaft portions respectively into the first and second through holes of the blade substrate, and the apparatus has the effect for eliminating the need for fixing the first and second shaft portions to the blade substrate by adhesion or welding as in the conventional manner. Further, since it is not necessary to fix by adhesion or welding, in contrast to conventional products in which adhesion or welding is performed and therefore it is necessary to use specific blade substrates with black pigments (carbon black) blended to the material to make the adhesion surface or welding surface hard to peel, it is possible to also use general blade substrates used in the conventional diaphragm apparatus with the material surface coated with black pigments (carbon black), and the merit is also high in cost. Furthermore, if the first and second shaft portions rattle in the shaft direction with respect to the blade substrate, the open/close action of diaphragm blades works without a hitch, the problems such as the malfunction and inoperative do not occur, and it is possible to provide the light quantity adjustment apparatus for enabling smooth open/close action of the diaphragm blades.

In the light quantity adjustment apparatus as described in claim 5 of the invention, in addition to the effect of the claim 3 as described above, the first and second shaft portions penetrate and support the blade substrate in the mutually opposite directions, and regulate the position of the blade substrate, the blade substrate is thereby not misaligned with respect to the first and second shaft portions, and it is possible to provide the light quantity adjustment apparatus for enabling correct exposure control to be performed particularly in a diaphragm aperture with small diameters.

In the light quantity adjustment apparatus as described in claim 6 of the invention, even when a plurality of diaphragm blades comprised of the above-mentioned diaphragm blades is overlapped in the so-called scales shape to form the diaphragm in which among three mutually adjacent blades one blade adjacent to the center blade is positioned on the lower side and the other adjacent blade is positioned on the upper side, the blade portion can warp with ease, the blades thereby do not adhere to one another and can be opened and closed smoothly, and the apparatus has the effect for enabling the occurrence of the malfunction and inoperative to be reduced.

In the light quantity adjustment apparatus as described in claim 7 of the invention, in a pair of boards that support the diaphragm blades to be openable and closable, it is configured that one of the boards is the driving ring, and that the other board is the base plate, the auxiliary board is integrally formed with the first shaft portion that engages in the shaft hole formed in the driving ring and the second shaft portion that is guided along the slit groove formed in the base plate, position interval accuracy of the first and second shaft portions is thereby improved, the support state of the first and second shaft portions and a pair of boards is more stabilized, and the apparatus has the effect for enabling smooth operation and formation of the correct diaphragm aperture.

The lens unit as described in claim 8 of the invention is equipped with the above-mentioned light quantity adjustment apparatus, it is thereby possible to perform exposure control correctly in the optical apparatus, and further, the optical apparatus of claim 9 provided with the lens unit has the same effect.

### BRIEF DESCRIPTION OF DRAWINGS

FIG. 1 is an exploded view of a light quantity adjustment apparatus according to Embodiment 1 of the invention;

FIG. 2 is a perspective explanatory view of an assembly exploded state of a first board (base plate) and blades in the apparatus of FIG. 1;

FIG. 3 is a perspective explanatory view of an assembly exploded state of a second board (hold-down plate) and blades in the apparatus of FIG. 1;

FIG. 4 shows a planar state of each component in the apparatus of FIG. 1, where FIG. 4A shows the first board (base plate), and FIG. 4B shows a first guide plate (first slide ring);

FIG. 5 shows a planar state of each component in the apparatus of FIG. 1, where FIG. 5A shows a driving ring, and FIG. 5B shows a second guide plate (second slide ring);

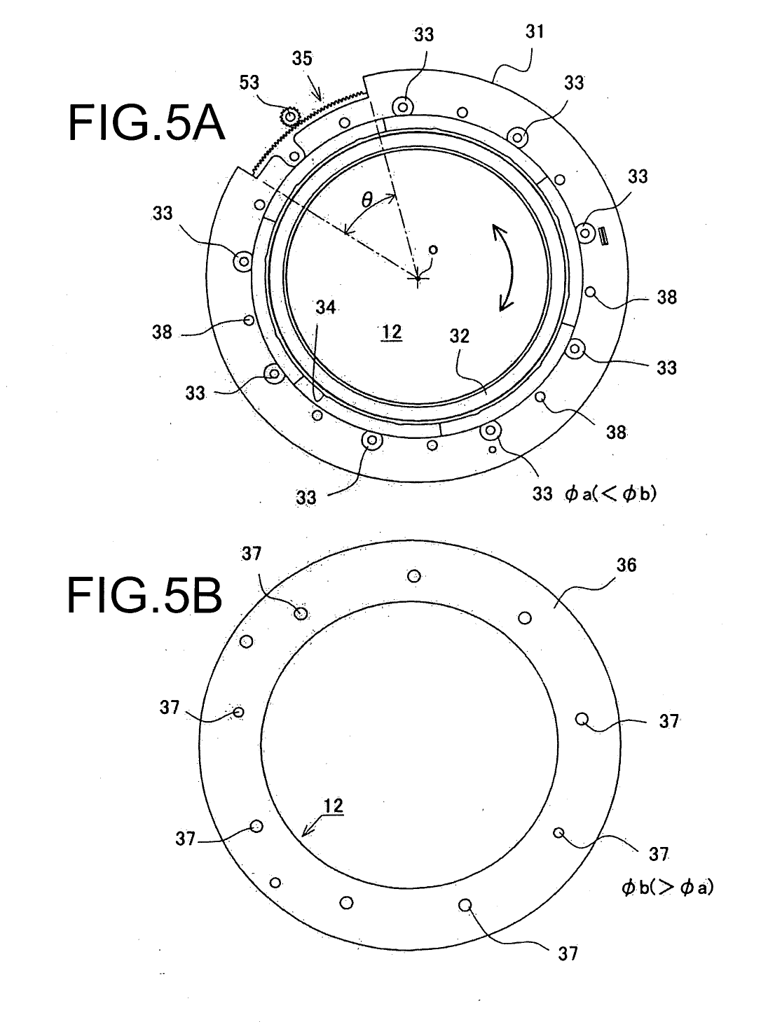

FIG. 6 shows an open/close state of diaphragm blades and the driving ring in the apparatus of FIG. 1, where FIG. 6A is an explanatory view showing a combination state of the diaphragm blades, and FIG. 6B is an explanatory view showing the relationship between the open/close trajectory of a blade and the driving ring;

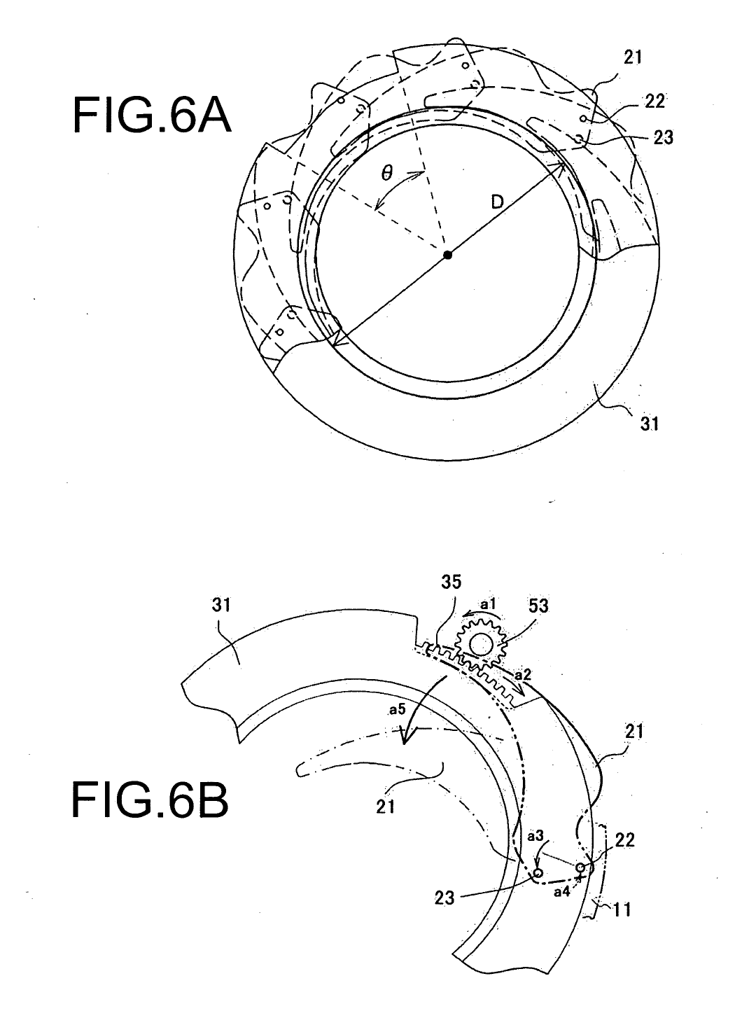

FIG. 7 contains explanatory views of an assembly state of the board, blade, and driving ring in the apparatus of FIG. 1, where FIG. 7A is a sectional view, FIG. 7B is an enlarged view of A part of FIG. 7A, and FIG. 7C is an enlarged view of B part of FIG. 7A;

FIG. 8 contains operation state explanatory views of the diaphragm blades in the apparatus of FIG. 1, where FIG. 8A shows a state of a large diameter, and FIG. 8B shows a state of a small diameter;

FIG. 9 is an explanatory view showing the open/close trajectory of the diaphragm blade in the apparatus of FIG. 1;

FIG. 10 contains explanatory views of one Embodiment of the diaphragm blades used in the apparatus of FIG. 1, where FIG. 10A shows an enlarged sectional structure of principal part thereof, and FIG. 10B is an exploded perspective view of the diaphragm blade;

FIG. 11 is an enlarged sectional view to explain a state change of the diaphragm blade shown in FIG. 10;

FIG. 12 is an explanatory view of an electromagnetic driving unit in the apparatus of FIG. 1;

FIG. 13 is a conceptual explanatory view of an image pickup apparatus with the apparatus of FIG. 1 incorporated thereinto;

FIG. 14 contains sectional views to explain the operation state of the diaphragm blades in the apparatus of FIG. 1, where FIG. 14A shows a state of a large diameter, and FIG. 14B shows a state of a small diameter;

FIG. 15 is a sectional view of principal part to explain a configuration of a conventional diaphragm unit:

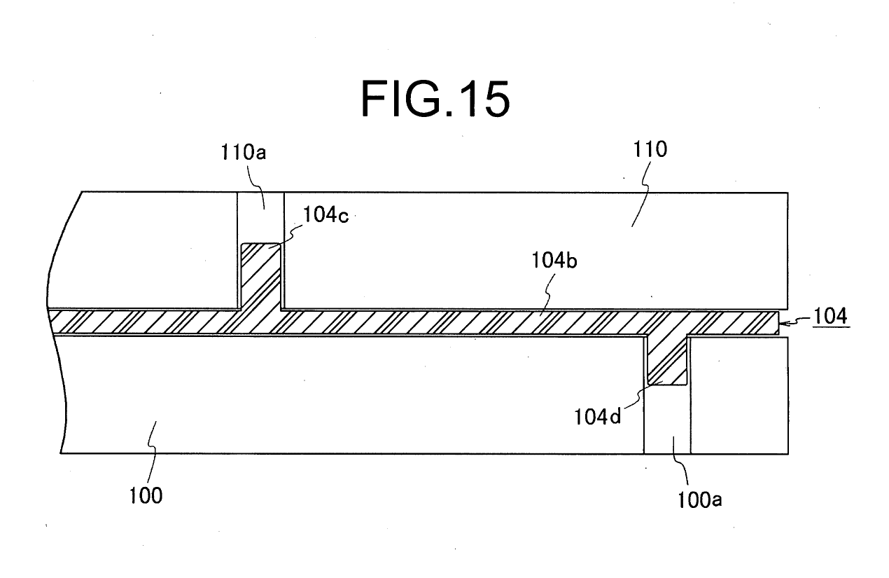

FIG. 16 is a sectional view to explain the problem of the diaphragm blade as shown in FIG. 15;

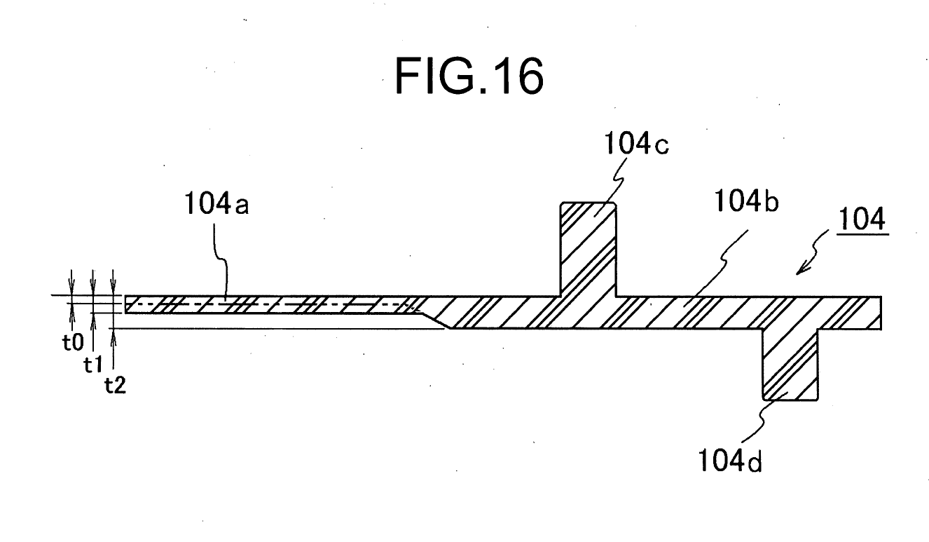

FIG. 17 is a sectional view of principal part to explain a configuration of another conventional diaphragm unit;

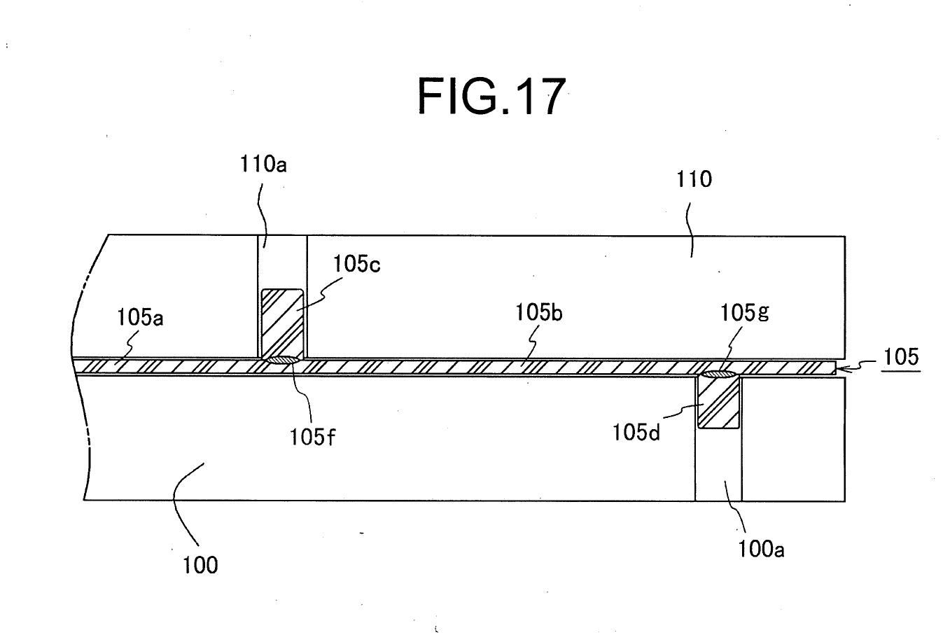

FIG. 18 contains sectional views to explain the problem of the diaphragm blade as shown in FIG. 17;

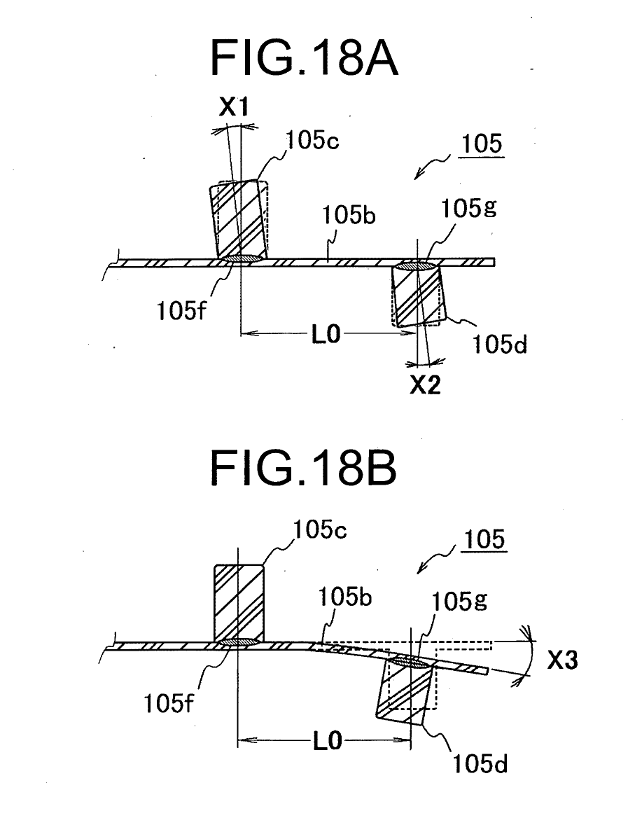

FIG. 19 is an exploded view of alight quantity adjustment apparatus according to Embodiment 2 of the invention;

FIG. 20 contains explanatory views to explain a configuration of each component in the apparatus of FIG. 19, where FIG. 20A is a perspective explanatory view of a diaphragm blade set, and FIG. 20B is a plan view of a second board (hold-down plate) viewed from the side of the diaphragm blade mount surface;

FIG. 21 contains explanatory views to explain a configuration of each component in the apparatus of FIG. 19, where FIG. 21A is a plan view of a first board (base plate) viewed from the diaphragm blade set side, and FIG. 21B is a perspective explanatory view of the first board (base plate);

FIG. 22 is a sectional view to explain the arrangement relationship of each component in the assembly state of the apparatus of FIG. 19;

FIG. 23 is a sectional view to explain a configuration of a single diaphragm blade constituting the diaphragm blade set as shown in FIG. 22;

FIG. 24 is an exploded sectional view of a single diaphragm blade constituting FIG. 23;

FIG. 25 contains perspective views of a single diaphragm blade of FIG. 23;

FIG. 26 contains schematic views to explain a support state of a single diaphragm blade in FIG. 22;

FIG. 27 contains perspective views showing another Embodiment of a single diaphragm blade of FIG. 25; and

FIG. 28 is an explanatory view showing the open/close trajectory of the diaphragm blade in the apparatus of FIG. 19.

### BEST MODE FOR CARRYING OUT THE INVENTION

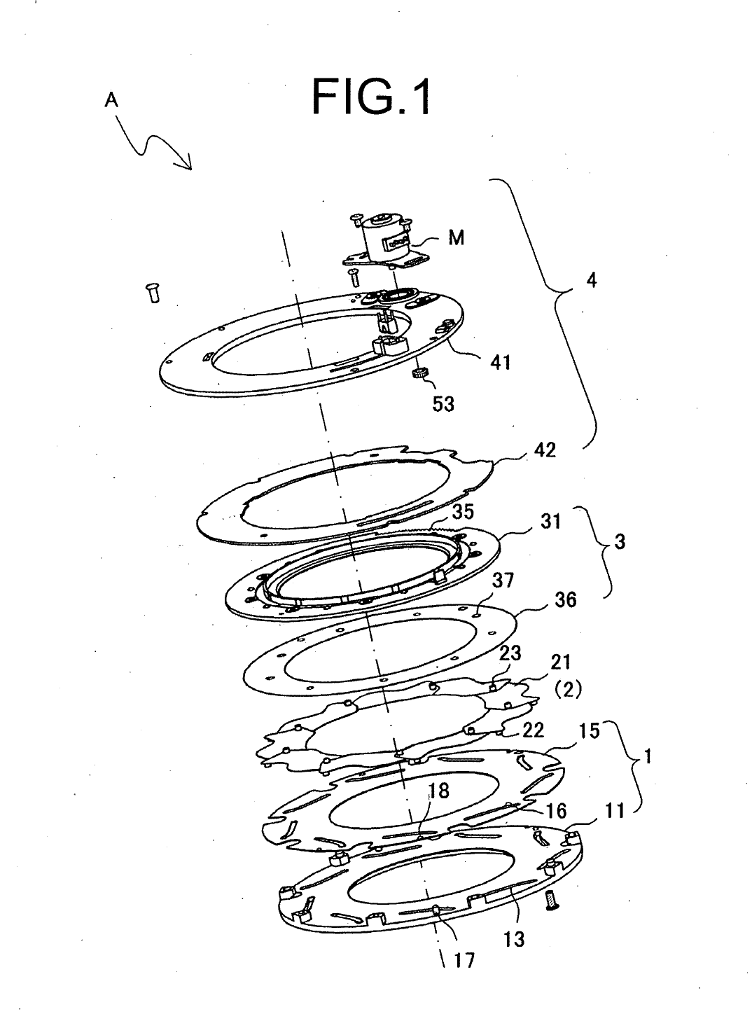

Embodiment 1 of the present invention will be described below based on preferred Embodiments shown in the figures. FIG. 1 is an exploded view of a light quantity adjustment apparatus A according to the invention. As shown in FIG. 1, the light quantity adjustment apparatus A is comprised of a first board set (base plate set) 1, blade set 2, second board set (driving ring set) 3, and hold-down plate set 4. Then, the blade set 2 is installed into between the first board set 1 and the driving ring set 3 to enable the set to perform open/close operation. By such a configuration, the blade set 2 is held by the first board set 1 and the second board set 3 in the shape of a sandwich, and the first and second board sets 1, 3 are integrated (not shown) with fixing screws together with the hold-down plate set 4.

### [Configuration of the First Board Set]

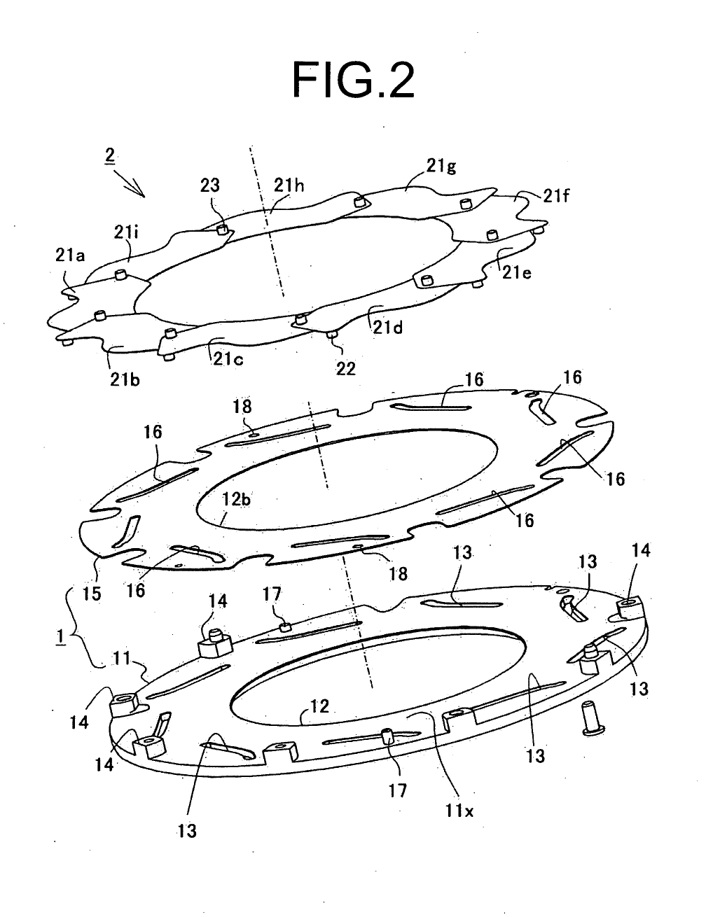

The configuration of the first board set 1 will be described first according to a partial enlarged view of FIG. 2. The first board set 1 is comprised of a base plate 11 and a first slide ring 15 (first guide plate; the same in the following description). Each component will be described.

### (Base Plate)

The base plate 11 has an exposure aperture 12, and is configured in the shape in accordance with the barrel shape of an image pickup apparatus. The base plate 11 is made of metal, resin or the like and formed in material and dimensions for providing the apparatus with toughness. The base plate 11 shown in the figure is formed by mold forming of a synthetic resin with reinforcement fibers such as glass fibers mixed. The reason is to make the base plate 11 thin, compact and light weight.

The base plate 11 is provided with the exposure aperture 12 in the center portion, a blade support surface 11x (flat surface or a concavo-convex surface) that supports the diaphragm blades is formed around the aperture, and in the support surface are formed guide grooves 13 that guide (regulate motion of) diaphragm blades in the open/close direction. The configuration of the guide grooves 13 will be described later. “14” shown in the figure denotes a coupling protrusion that secures a hold-down plate 41, and a screw hole is formed inside the protrusion.

### (First Guide Plate)

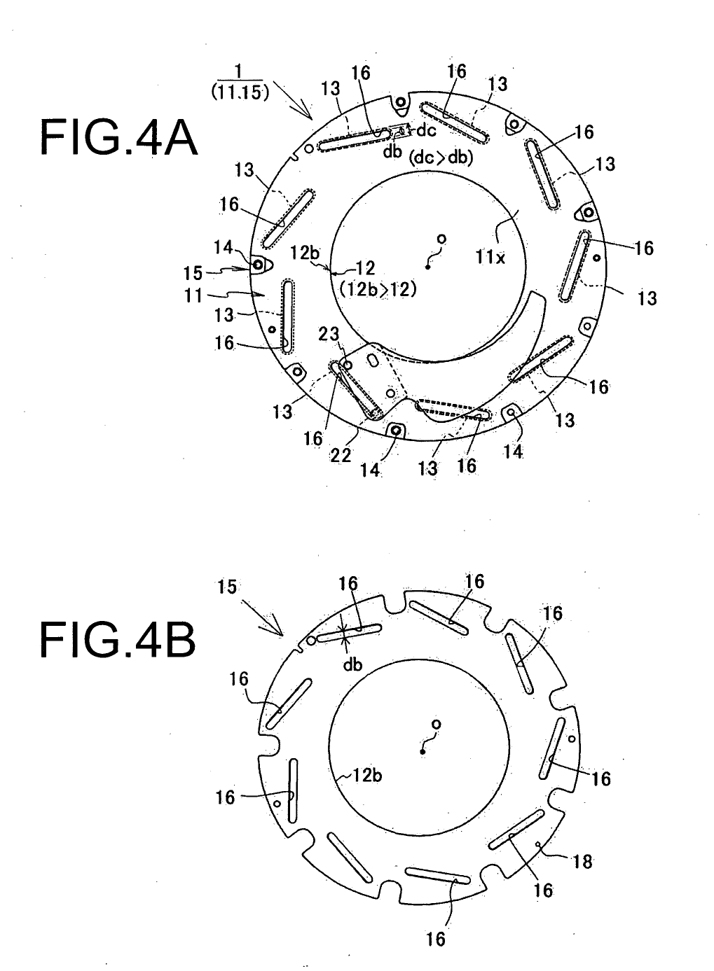

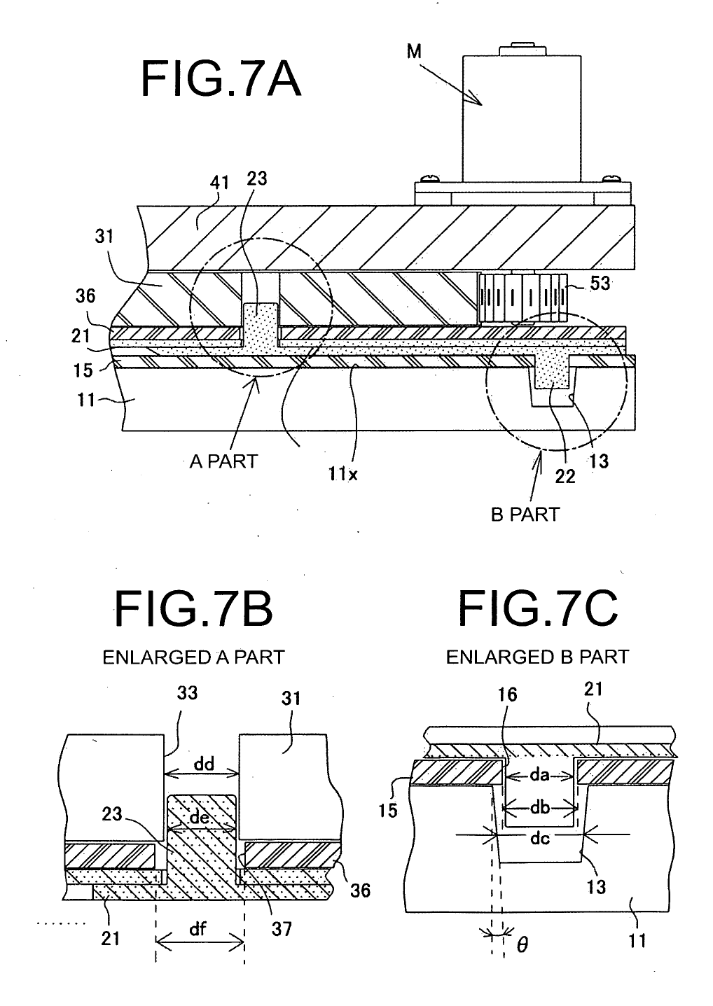

As shown in FIG. 2 showing the perspective structure and in FIG. 4B showing the planar structure, the first guide plate (first slide ring) 15 is formed in the shape of a ring that is approximately the same shape as the base plate 11. As shown in FIG. 7A showing the sectional structure, the first guide plate 15 is provided between the blade support surface 11x of the base plate 11 and diaphragm blades 21, and prevents the blades 21 from directly coming into contact with the base plate 11. The first guide plate 15 shown in the figure is formed approximately in the same planar shape as the base plate 11.

The first guide plate 15 is formed of a resin film with a low coefficient of friction with respect to the blade members 21, described later. The first guide plate 15 shown in the figure is made of the same material as the diaphragm blades 21, described later, and for example, is formed by die-cutting forming of a polyethylene resin film (PET sheet). Then, as the shape is shown in FIG. 4B, the plate 15 is provided with guide grooves 16 coincident with the guide grooves 13 of the base plate 11.

Accordingly, when the base plate 11 is formed by mold forming using a resin, and the first guide plate 15 is formed by die-cutting forming using a resin film, it is possible to form the first guide plate 15 with a high degree of shape accuracy as compared with shape accuracy of the base plate 11. This is because dimension accuracy is obtained by performing die-cutting forming on a material formed in the shape of a sheet by roll forming, as compared with mold forming. Further, by making the material of the first guide plate 15 the same as the material of the diaphragm blades 21, temperature characteristics such as a thermal change are substantially the same as the blade members, the blades 21 and guide plate 15 are of the same material and have the same electrification rank, and therefore, static electricity is not charged when both of the members slide.

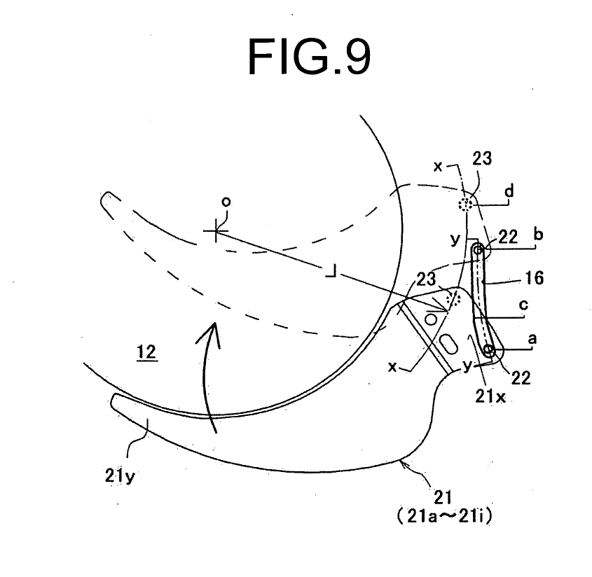

The first guide plate 15 shown in the figure is formed approximately in the same shape as the base plate 11, supports base end portions 21x of a plurality of diaphragm blades 21 around the exposure aperture 12 positioned at the center, and supports blade portions 21y to face the inside of the exposure aperture (see FIG. 9).

In addition, the guide groove 16 of the first guide plate 15 is formed in the size smaller than the guide groove 13 of the base plate 11 as shown in FIGS. 4A and 7C, and forms a guide reference of a guide pin 22 of the blade member, as described later. Accordingly, the guide groove 13 of the base plate 11 is formed larger not to contact even when the guide pin 22 inclines to a certain extent, and as the function, covers so that outside light is not incident from the guide groove 16.

Further, in regard to the first guide plate 15, when measures against static electricity are taken by another method, it is possible to provide the structure of only the base plate 11, and in this case, as a substitute for the guide groove 16 of the first guide plate 15, it is possible to use the guide groove 13 of the base plate 11 as a guide reference of the guide pin 22 of the blade member.

### [Blade Member]

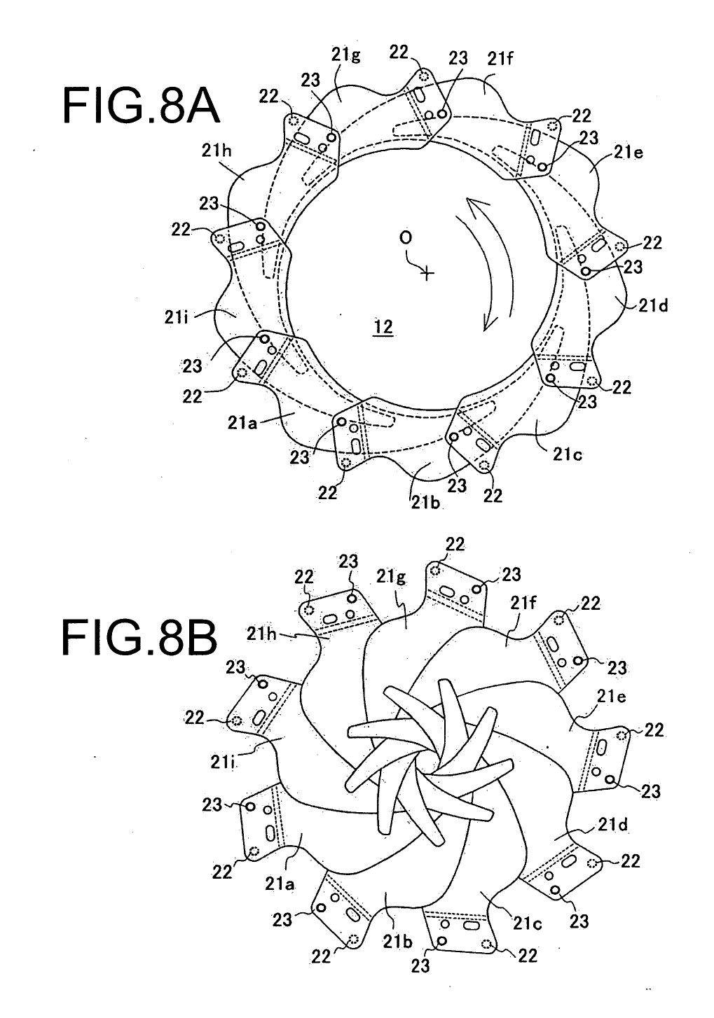

A configuration of the blade set 2 will be described next according to FIGS. 8 to 10. As shown in FIG. 8, the blade set 2 is comprised of a plurality of diaphragm blades 21a to 21i. The diaphragm blades 21 shown in the figure are comprised of nine blades, and the shape of each blade is formed in the same shape. FIG. 9 shows the operation state of the diaphragm blades 21, and the base end portion 21x is supported by the base plate 11 via the above-mentioned first slide ring 15. Further, the blade portion 21y of the blade opens and closes the exposure aperture 12. At this point, the blade portions 21y of a plurality of blade members overlap one another in the shape of scales, reduce the exposure aperture 12 between the large diameter in FIG. 8A and the small diameter in FIG. 8B and adjust the quantity of light.

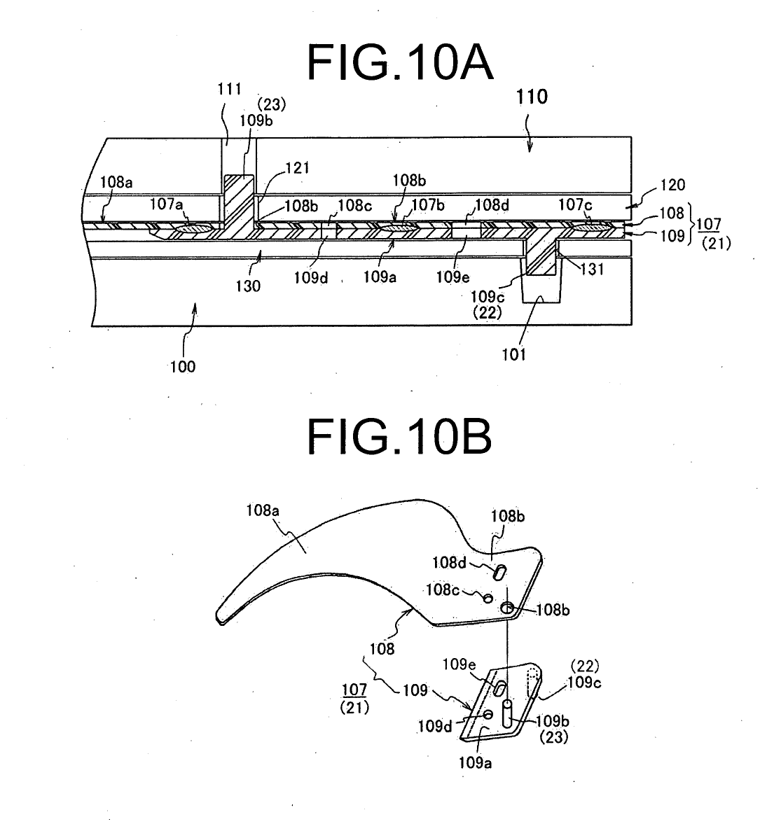

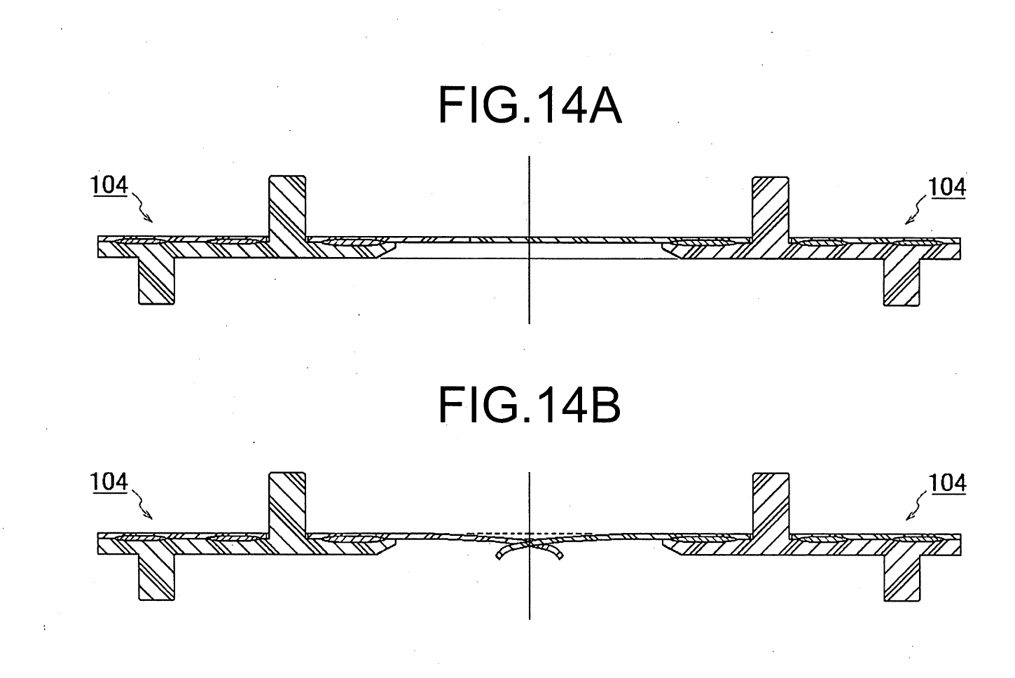

The blade members 21a to 21i will specifically be described according to one Embodiment as shown in FIGS. 10, 11 and 14. In addition, FIG. 9 is an explanatory view showing the open/close trajectory of the diaphragm blade in the apparatus of FIG. 1, FIG. 10 contains explanatory views of one Embodiment of the diaphragm blades, where FIG. 10A shows an enlarged sectional structure of principal part thereof, and FIG. 10B is an exploded perspective view of the diaphragm blade, and FIG. 14 contains sectional views to explain the operation state of diaphragm blades in the apparatus of FIG. 1, where FIG. 14A shows a state of a large diameter, and FIG. 14B shows a state of a small diameter.

First, as shown in FIG. 10B, a blade member 107 (21) is comprised of a blade substrate 108 and an auxiliary substrate 109. The blade substrate 108 is obtained by die-cutting, by pressing, a sheet material formed in the shape of a sheet by rolling processing of a resin material (polyester) with black pigments blended, in the shape of a blade comprised of a blade portion 108a and a base end portion 108b, and in the base end portion 108b are formed a shaft hole 108b, positioning hole 108c and long hole 108d. The auxiliary substrate 109 is formed in almost the same shape as the outside shape of the base end portion 108b with a resin material (polycarbonate), and a first shaft portion 109c (guide pin 22) and a second shaft portion 109b (operating pin 23) are respectively planted on the front side and back side. The first shaft portion 109c is disposed in the position facing the second board 100 (base plate 11) side in each blade member, and the second shaft portion 109c is disposed on the opposite side (on the second board side as described later). As described later, the first shaft portion 109c (guide pin 22) is configured so that the basal portion is fitted into the guide groove 16 of the first guide plate 15, and that the front end portion is put inside the guide groove 13. Further, the second shaft portion 109c (operating pin 23) protrudes from the shaft hole 108b of the blade substrate 108, and is fitted into a shaft hole 121 (33) of the first board 110 (operating member 31), described later. Furthermore, a positioning hole 109d and long hole 109e are formed in positions respectively opposed to the positioning hole 108c and long hole 108d of the blade substrate 108, and in manufacturing each blade member 21a to 21i, with both the blade substrate 108 and the auxiliary substrate 109 positioned using a tool, as shown in 10A, a laser is applied to weld welding portions 107a, 107b and 107c as appropriate and integrate. In addition, the blade substrate 108 and the auxiliary substrate 109 may be integrated using another fixing means such as an adhesive or the like.

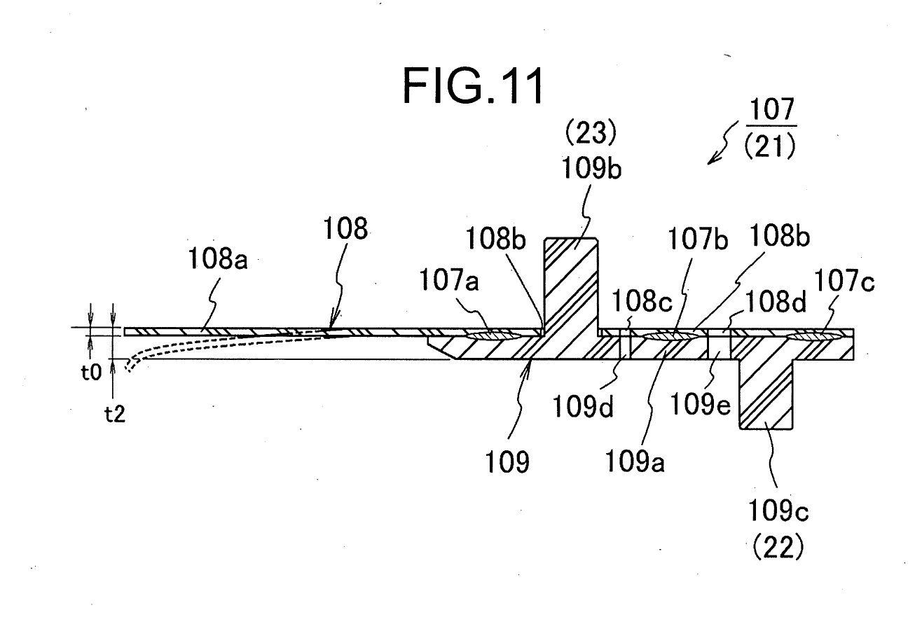

Further, the reason why the blade substrate 108 is arranged on the first board 110 (operating member 31) side and the auxiliary substrate 109 is arranged on the second board 100 (base plate 11) side is that in the state in which the diaphragm diameter is the small diameter as shown in FIG. 8B, for example, blade portion front ends of blade members 21b to 21e are inserted in between the blade portion front end of the blade member 21a and the blade portion front end of the blade member 21f. As a result, as shown in FIGS. 11 and 14, the blade portion 108a of the blade member 107 (21) curls up as shown by the dotted lines. At this point, as shown in the figures, by the blade substrate 108 bowing in the direction for enveloping the auxiliary substrate 109, the load for peeling the blade substrate 108 away from the auxiliary substrate 109 is not applied to the base end portion 108b of the blade member 107 (21), and peeling is hard to occur, thereby preventing events of the malfunction and inoperative from occurring.

### [Relationship Between the Guide Groove and the Guide Pin]

Described next is the relationship between the guide groove 13 formed in the above-mentioned base plate 11 and the guide groove 16 formed in the first guide plate 15, and the guide pin 22 (first shaft portion 109c) formed in each blade member 21.

As shown in FIGS. 7A and 7C, the guide groove 13 of the base plate 11 is comprised of a concave groove and is formed in the shape of a blind hole which light outside the base plate does not pass through. Further, in relation to the fact that the base plate 11 is formed by mold forming, a cutting taper e is formed, and the average inside diameter is set at dc.

Further, the guide groove 16 of the first guide plate 15 is formed of a through hole with the inside diameter of db. The through hole is formed in a uniform diameter by die-cutting forming using a resin film.

Meanwhile, the guide pin 22 is planted in each of the diaphragm blades 21a to 21i, and the outside diameter of the pin is set at da. Then, the relationship between the pin outside diameter da and the guide groove inside diameter db is set at the relationship of da≦db□dc. In other words, the guide groove 16 of the first guide plate 15 has a narrower width (db<dc) than that of the guide groove 13 of the base plate 11, and is set at a dimension adapted to the guide pin outside diameter da (da≦db).

Accordingly, as shown in the figures, the guide pin (first shaft portion 109c (22)) 22 plated in each of the blade members 21a to 21i engages in the guide groove 16 of the first guide plate 15, is regulated in motion, and does not come into contact with the guide groove 13 of the base plate 11. Therefore, it does not happen that the guide pin (first shaft portion 109c (22)) 22 engages in the guide groove 13 of the base plate 11 having the taper θ unstably. By this means, the blade members 21 neither incline nor float.

### [Configuration of the Second Board Set]

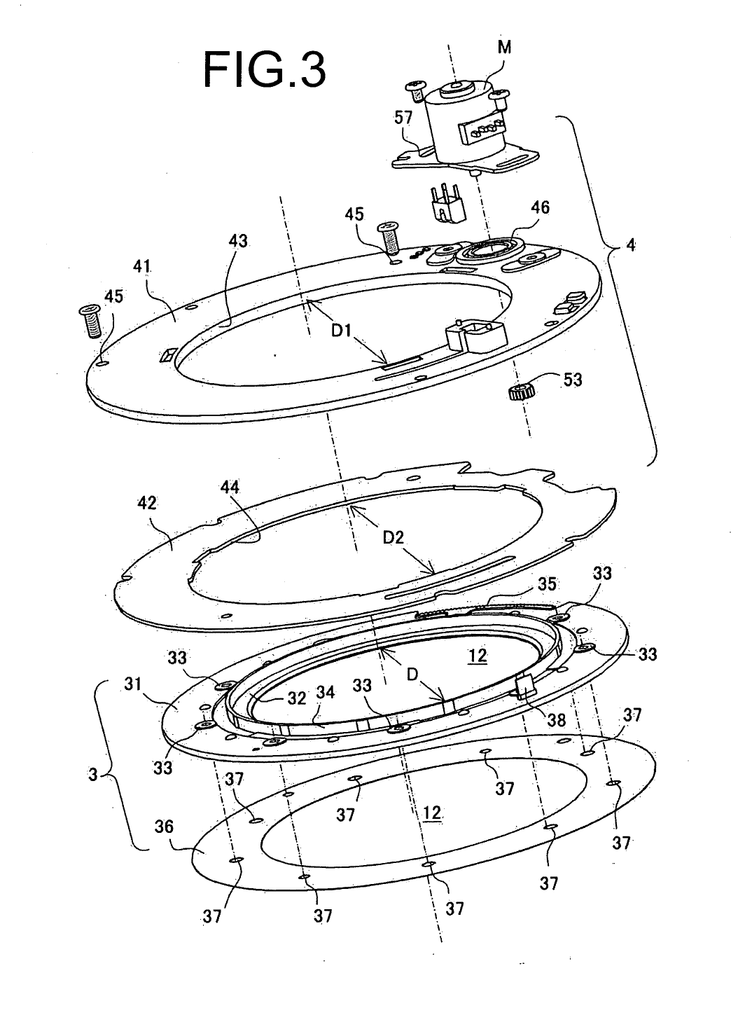

The second board set (driving ring set) 3 and the hold-down plate set 4 will be described according to FIG. 3. The hold-down plate set 4 is comprised of the hold-down plate 41, a reinforcing plate 42 and a driving unit M secured to the hold-down plate. Further, the second board set (driving ring set) 3 is comprised of the operating member (driving ring) 31, and second slide ring (second guide plate) 36. Each configuration will be described below.

### [Hold-Down Plate]

As shown in FIG. 3, the hold-down plate 41 is formed in the shape of a ring having an aperture 43 in the center portion, and is formed approximately in the same shape as the above-mentioned base plate 11. The hold-down plate 41 shown in the figure is of mold forming using a resin, and a mount 46 of the driving unit M is provided in part of the outer region. In the mount 46, the driving unit M, described later, is fastened with screws or the like. “45” shown in the figure denotes a coupling hole to fasten the hold-down plate 41 to a coupling protrusion 14 of the base plate 11 with a screw.

### [Reinforcing Plate]

As shown in FIG. 3, the reinforcing plate 42 is comprised of a relatively strong plate material such as metal, and reinforces the hold-down plate 41 made of a resin. Accordingly, when sufficient strength is obtained in the hold-down plate 41, it is possible to eliminate the reinforcing plate 42. The reinforcing plate 42 is formed approximately in the same shape as the hold-down plate 41, and an aperture 44 is formed at the center.

Each of the aperture 43 of the hold-down plate 41 and the aperture 44 of the reinforcing plate 42 is set to be larger than the aperture diameter D of the exposure aperture 12, and the aperture diameter D1 of the aperture 43, the aperture diameter D2 of the aperture 44 and the aperture diameter D of the exposure aperture 12 are set at D2≧D1□D.

The second board set (driving ring set) 3 is comprised of the operating member (driving ring) 31 that conveys driving of the driving motor (driving unit, described later) M to the diaphragm blades 21, and the second slide ring (second guide plate) 36.

### [Driving Ring]

As shown in FIG. 3, the operating member (driving ring) 31 is formed in the shape of a ring (hereinafter, referred to as the “driving ring”) having the exposure aperture 12 in the center portion, for example, by mold forming using a resin. The driving ring 31 is attached rotatably to the hold-down plate 41 via the reinforcing plate 42. Therefore, in the driving ring 31, a fringe 32 and engagement protrusion 34 are formed around the exposure aperture 12. The fringe 32 is fitted into the aperture 43 of the hold-down plate 41 and the aperture 44 of the reinforcing plate 42, and rotates about the rotation center coinciding with the center of the exposure aperture 12. Further, the engagement protrusion 34 is formed on the surface that comes into slide-contact with the reinforcing plate 42, and helps both members to slide smoothly.

The driving ring 31 is incorporated into the hold-down plate 41 to be rotatable as described above, and passive teeth 35 are formed in part of the circumference. The passive teeth 35 are provided in a position to mesh with a driving gear 53 of the driving unit M, described later, attached to the mount 46 of the hold-down plate 41.

In the driving ring 31, a fit hole 33 that is fitted into the operating pin (second shaft portion 109b) 23 planted in each of the diaphragm blades 21a to 21i is provided around the exposure aperture 12. The fit hole 33 is disposed in a plurality of portions (in the figure, nine portions) around the exposure aperture 12 corresponding to the number of diaphragm blades 21.

In such a configuration, the driving ring 31 is supported by the hold-down plate 41 rotatably, and rotates a predetermined angle by the driving gear 53 of the driving unit M. Then, rotation of the driving ring 31 is conveyed to each of the blade members 21a to 21i.

### [Second Guide Plate]

As shown in FIG. 3, the second guide plate (second slide ring; the same in the following description) 36 is formed of a resin film (for example, a resin film of polyethylene or the like) having the exposure aperture 12 at the center, and is provided between the driving ring 31 and blade members 21. This is because of preventing the blade members 21 and driving ring 31 from directly coming into contact with each other, and obtaining smooth open/close motion of the diaphragm blades. The second guide plate 36 shown in the figure is made of the same material as the diaphragm blades 21. This is because by thus using the same material in the blades and slide ring that mutually slide, temperature characteristics such as a thermal change are substantially the same as the blade members, the blades and slide ring are of the same material and have the same electrification rank, and therefore, static electricity is not charged when both of the members slide.

The second guide plate 36 is formed in the shape of a ring similar to the driving ring 31. In the second guide plate 36, engagement holes 37 are provided in positions coincident with the fit holes 33 of the driving ring 31. In the fit hole 33 of the driving ring 31 and the engagement hole 37 of the slide ring, as shown in FIG. 7B, the relationship in the outside diameter de of the second shaft portion 109b (operating pin) 23 formed in each blade, the diameter dd of the fit hole 33 of the driving ring 31, and the diameter df of the engagement hole 37 of the second guide plate 36 is set as the following equation.

de≦dd□df (Eq. 1)

In other words, the outside diameter de of the operating pin (second shaft portion 109b) 23 of the blade and the diameter dd of the fit hole 33 of the driving ring 31 are fitted to be mutually adapted, and the diameter df of the engagement hole, 37 of the second guide plate 36 is set to be sufficiently larger than the outside diameter de of the operating pin (second shaft portion 109b) 23. By this means, the operating pin (second portion 109b) 23 of the blade is substantially fitted into the fit hole 33 of the driving ring 31, and does not engage in the engagement hole 37 of the second guide plate 36.

Described below is the reason that the fit hole 33 (diameter dd) of the driving ring 31 is thus set at a diameter smaller than the engagement hole 37 (diameter df) of the second guide plate 36. The second guide plate 36 exists between the driving ring 31 and the blades 21. Therefore, the second guide plate 36 also performs rotation motion by open/close motion of the blades 21 or rotation motion of the driving ring 31. At this point, when the engagement hole 37 of the second guide plate 36 and the fit hole 33 of the driving ring 31 are misaligned or the hole diameter differs by processing accuracy, as shown in FIG. 8B, a phase difference Δt1 occurs between engagement holes. The phase difference affects open and close of blades as a backlash.

When such a backlash (phase difference Δt1) exists, in a plurality of diaphragm blades, some blade rotates faster by Δt1, while another blade rotates slower by Δt1. Then, open/close misalignment occurs in the front ends of the blades. Therefore, in the invention, the hole diameters are set so that the engagement hole 37 of the second guide plate 36 is set to be larger than the fit hole 33 of the driving ring 31, and does not engage in the operating pin (second shaft portion 109b) 23 of the blade.

### [Driving Unit M]

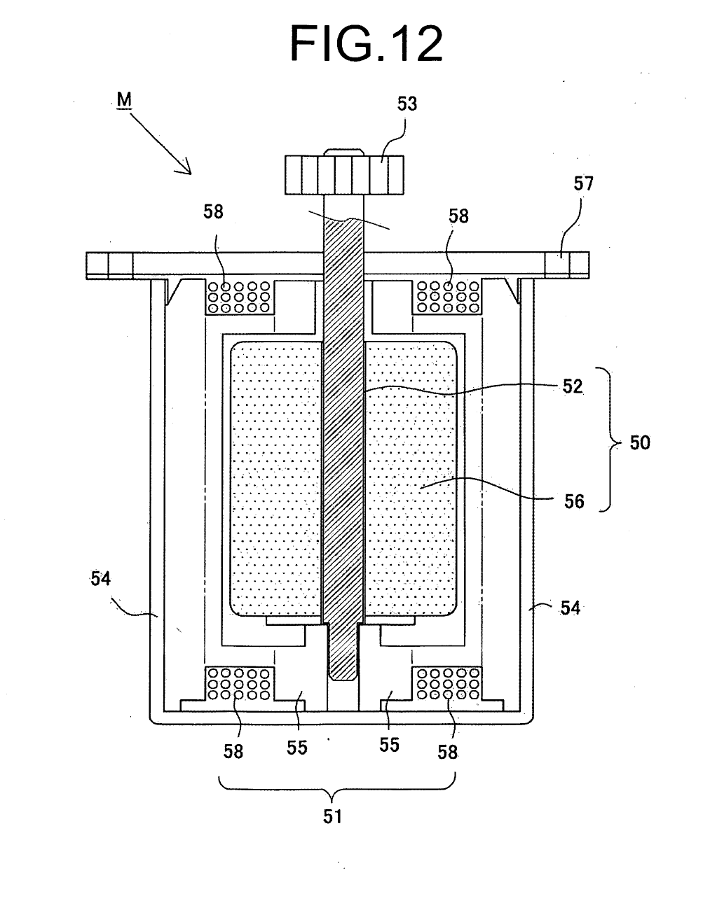

FIG. 12 shows one Embodiment of the driving unit M. The driving unit M in FIG. 12 is comprised of a magnet rotor 50, stator coil 51, driving rotating shaft 52, driving gear 53, and yoke 54. The magnet rotor 50 is configured by integrating the driving rotating shaft 52 and permanent magnets 56, and opposite end portions of the driving rotating shaft 52 are bearing-supported by a coil frame 55. In the permanent magnets 56 two, NS, poles are formed around the periphery, and the driving gear 53 is attached to the driving rotating shaft 52. Further, the stator coil 51 is comprised of the coil frame 55 and coil 58 wound around the frame. The coil frame 55 is divided into two, left and right, or upper and lower, portions to incorporate the rotor into the inside. A bracket 57 is integrally formed in the coil frame 55, and the yoke 54 is fitted and installed on the periphery.

In such a configuration, when power is applied to the coil 58, the magnet rotor 50 rotates a predetermined angle forward or backward in a clockwise direction or a counterclockwise direction to rotate the driving gear 53 forward and backward. Thus configured driving unit M is fastened in the bracket 57 to the mount 46 of the hold-down plate 41 with screws or the like. Then, the driving gear 53 meshes with the passive teeth 35 of the driving ring 31. By this means, the driving ring 31 reciprocates by a predetermined angle in a clockwise direction and counterclockwise direction in FIG. 3, and opens and closes the diaphragm blades 21.

### [Explanation of the Assembly State]

The assembly state of the light quantity adjustment apparatus A will be described according to FIG. 1. As described above, with the driving unit M first mounted on the hold-down plate 41, the reinforcing plate 42 is overlaid, the hold-down plate set 4 is assembled, and the driving ring 31 is put thereon so that the driving gear 53 of the driving unit M meshes with the passive teeth 35 of the driving ring 31. Further, the second guide plate 36 is overlaid on the driving ring 31, hole positions are aligned in the engagement hole 37 of the second guide plate 36 and the fit hole 33 of the driving ring 31, and the second board set 3 is assembled.

Then, with respect to the second board set 3, as shown in FIG. 2, while the operating pin (second shaft portion 109b) 23 of each of the first to ninth diaphragm blades 21a to 21i is fitted into the fit hole 33 of the driving pin 31 via the engagement hole 37 of the second guide plate 36, the first to ninth diaphragm blades 21a to 21i are successively overlaid. In addition, as shown in FIG. 8, the blade portion 21y of the ninth diaphragm blade 21i to overlay finally is inserted to be below the base end portion 21x of the first diaphragm 21a. By performing this assembly, it is possible to pile the first to ninth diaphragm blades 21a to 21i in the so-called scales shape so that any diaphragm blade 21 of the first to ninth diaphragm blades 21a to 21i is positioned above one of adjacent diaphragm blades 21, while being positioned below the other diaphragm blade 21. By reducing the diaphragm blades thus piled in the shape of scales to a small diameter, respective blade portions of the first to ninth diaphragm blades 21a to 21i are overlapped as shown in FIG. 8B, and it is thereby possible to hold in almost parallel with the diaphragm aperture plane without support of the first board set 1 in the state of the small diameter shown in the figure.

Next, the first guide plate 15 is overlaid on the base plate 11, groove positions are aligned in the guide groove 16 of the first guide plate 15 and the guide groove 13 of the base plate 11, the first board set 1 is assembled, and is overlaid on each of the blade members 21a to 21i in the upside-down state as shown in FIG. 2 with the first to ninth diaphragm blades 21a to 21i successively overlaid on the second board set 3, the guide pin (first shaft portion 109c (22)) 22 of each blade member 21 is fitted into the guide groove 16 of the first guide plate 15, and the front end portion of the guide pin (first shaft portion 109c (22)) 22 of each blade member 21 is stored inside the guide groove 13.

Then, the base plate 11 and hold-down plate 41 are fixed with fixing screws. By this means, the base plate 11, first guide plate 15, blade members 21, second guide plate 36, driving ring 31, reinforcing plate 42, and hold-down plate 41 are successively stacked upward as shown in FIG. 1 and integrated.

### [Open/Close Action of the Blades]

The open/close action of the diaphragm blades will be described next according to FIGS. 8 and 9. FIG. 8A shows a state of a large diameter in which a plurality of diaphragm blades is disposed around the exposure aperture 12, and FIG. 8B shows a state of a small diameter. FIG. 9 shows the open/close action state of one of the plurality of diaphragm blades. As shown in FIG. 8A, a plurality of diaphragm blades 21a to 21i is arranged in positions (in the apparatus shown in the figure, nine blades in positions angularly spaced every 40 degrees) spaced a predetermined angle with reference to the light-path center O in the shape of scales. In each of the diaphragm blades 21a to 21i, the guide pin 22 is fitted into the guide groove 13 formed in the base plate 11. Concurrently therewith, the operating pin 23 formed in each of the diaphragm blades 21a to 21i is fitted into the shaft hole 33 of the driving ring 31.

Then, the driving ring 31 rotates about the light-path center O in a clockwise direction and a counterclockwise direction in the range of a predetermined angle by the driving unit M described previously. The open/close action of the blade at this point will be described according to FIG. 9. The operating pin 23 rotationally shifts from point c to point d shown in the figure in a clockwise direction in FIG. 9 by the arc trajectory x-x with a radius L from the light-path center O shown in the figure by rotation of the driving ring 31. Further, the guide pin 22 shifts from point a to point b by the trajectory y-y shown in the figure along the guide groove 16.

By the shifts of the operating pin 23 and the guide pin 22, the diaphragm blade 21 is opened and closed from the solid line (large-diameter state) in FIG. 9 to the dashed lines (small-diameter state) in FIG. 9. In addition, in the apparatus shown in the figure, the exposure aperture 12 is set for a small diaphragm state in the small-diameter state, while being set for a full aperture state in the large-diameter state. Accordingly, corresponding to the current supplied to the driving unit M, the diaphragm blades 21 are opened and closed in arbitrary aperture diameters from the small diaphragm state to the full aperture state, and adjust the quantity of light passing through the exposure aperture 12 to be larger and smaller.

### [Image Pickup Apparatus]

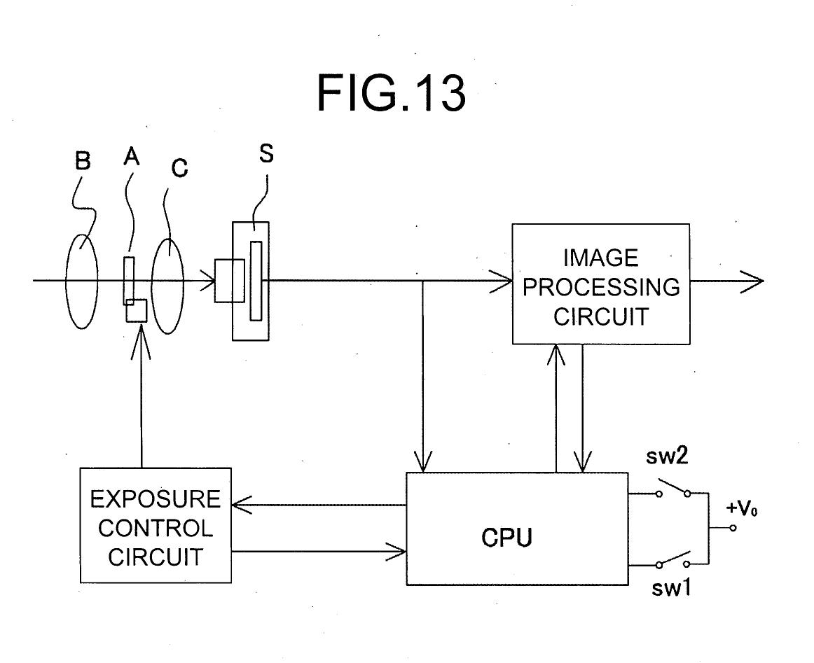

An image pickup apparatus using the above-mentioned light quantity adjustment apparatus A will be described next based on FIG. 13. The above-mentioned light quantity adjustment apparatus is incorporated into a lens barrel of a still camera, video camera, etc. “B” shown in the figure denotes a front lens disposed in the shooting light path, “C” denotes a back lens, an image of a subject image is formed by the lenses, and an image pickup means S is disposed in the image formation surface. As the image pickup means S, a solid-state image sensing device such as a CCD, a photosensitive film or the like is used. Then, it is configured that control is executed by a CPU control circuit, exposure control circuit, and shutter driving circuit. “SW1” shown in the figure denotes a main power supply switch, and “SW2” denotes a shutter release switch. As control as a camera apparatus, as well as the circuits, an autofocus circuit or the like is used, the configuration is well known, and therefore, the description is omitted.

Then, a diaphragm apparatus E and shutter apparatus (not shown) are installed in between the front lens B and back lens C incorporated into the lens barrel. Into the diaphragm apparatus E are incorporated the diaphragm blades 21 as described previously and the driving unit M. Then, the control CPU sets shooting conditions such as an exposure amount and shutter speed, and issues direction signals to the exposure control circuit and shutter driving circuit. First, as the exposure amount, the exposure control circuit supplies a current in the predetermined direction to the coil of the driving apparatus M by a direction signal from the control CPU. Then, the rotation of the driving apparatus M is conveyed to the diaphragm blades 21 from the operating pins 23 via the driving gear 53, and the diaphragm blades 21 stop the exposure aperture 12 to an optimal exposure amount.

Next, when a release button is operated, in the case of the solid-state image sensing device such as a CCD, the already charged charge is released, and shooting is started. Then, after a lapse of exposure time beforehand set by the control CPU, the shutter driving circuit receives a signal for starting shutter action, and supplies a current in the shutter close direction to the coil of the driving apparatus. After the shutter action, in the case that the image pickup means S is the CCD (solid-state image sensing device), image data is transferred to an image processing circuit and stored in a memory or the like.

The light quantity adjustment apparatus as described above is used by being installed into an optical apparatus, not shown, but for example, a camera, projector, light microscope or the like provided with a taking lens, the light quantity adjustment apparatus that adjusts a quantity of light passing through the taking lens, and receiving means for receiving light of the quantity of light that is adjusted by the light quantity adjustment apparatus and that passes through the taking lens.

This Embodiment discloses the configuration in which the auxiliary substrate 109 provided with the first and second shaft portions is attached to the blade member 21, but the present invention is not limited thereto, and may adopt a configuration of blade members 20 of Embodiment 2 as described below. In addition, the common mechanisms are assigned the same reference numerals to omit the descriptions thereof.

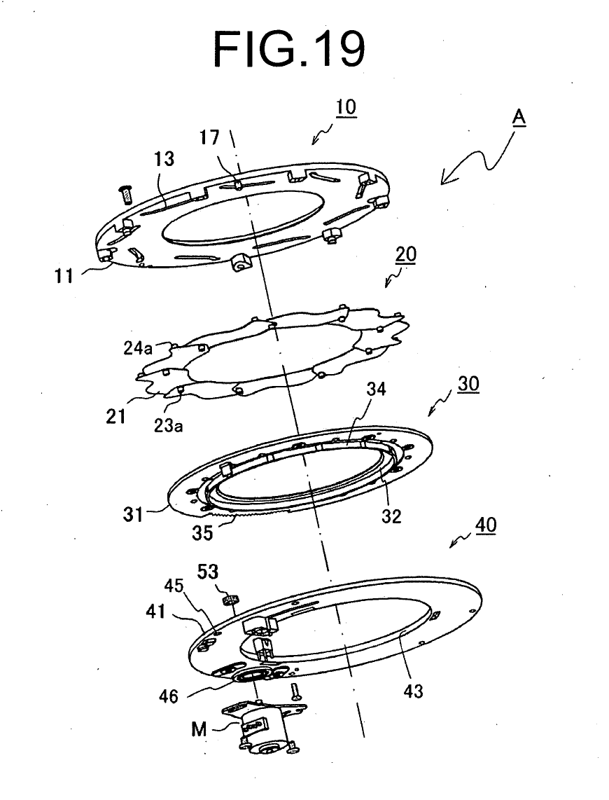

FIG. 19 is an exploded view of a light quantity adjustment apparatus A according to the invention. As shown in FIG. 19, the light quantity adjustment apparatus A is comprised of a first board (base plate) 10, diaphragm blade set 20, second board (driving ring) 30, and hold-down member 40. Then, the diaphragm blade set 20 is installed into between the first board 10 and the second board 30 to enable the set to perform open/close operation. By such a configuration, the diaphragm blade set 20 is held by the first board 10 and the second board 30 in the shape of a sandwich, and the first board 10 and second board 30 in the sandwich shape are integrated (not shown) with fixing screws together with the hold-down member 40.

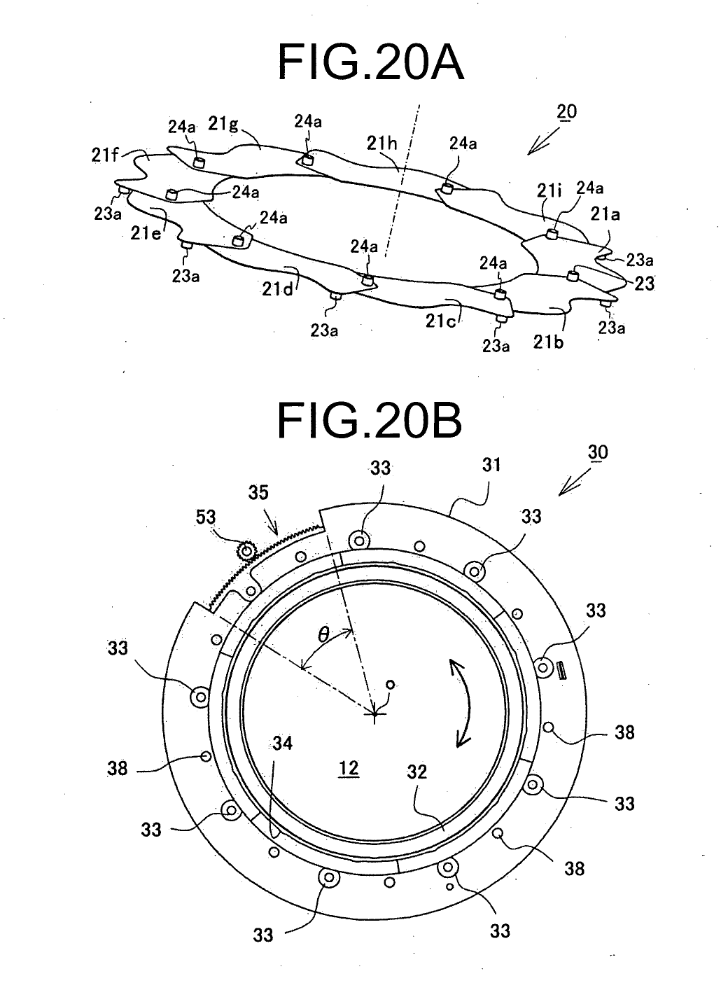

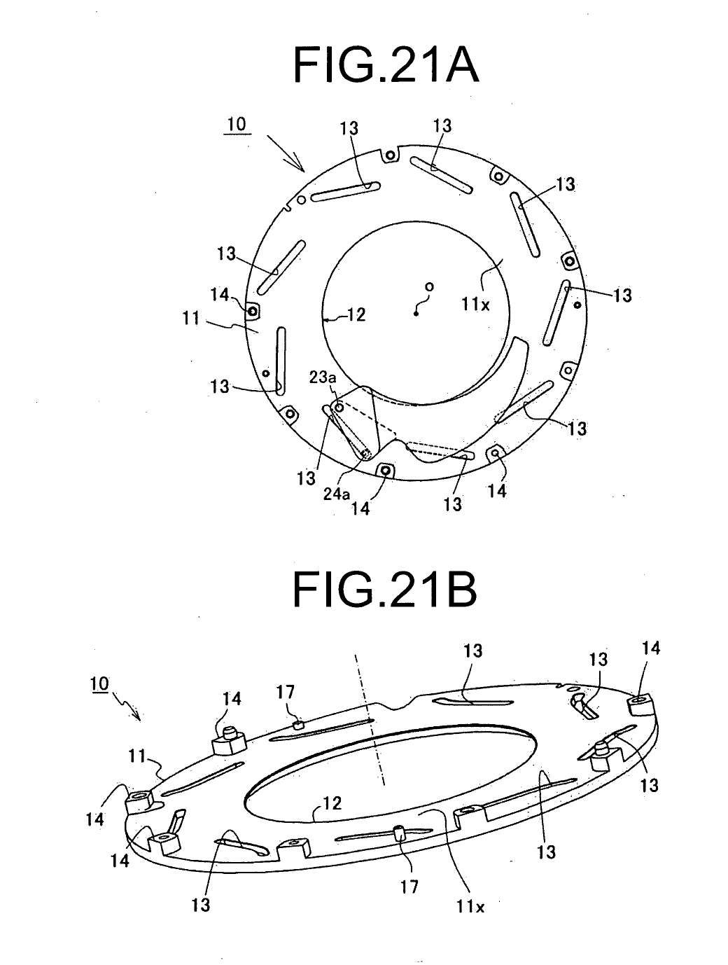

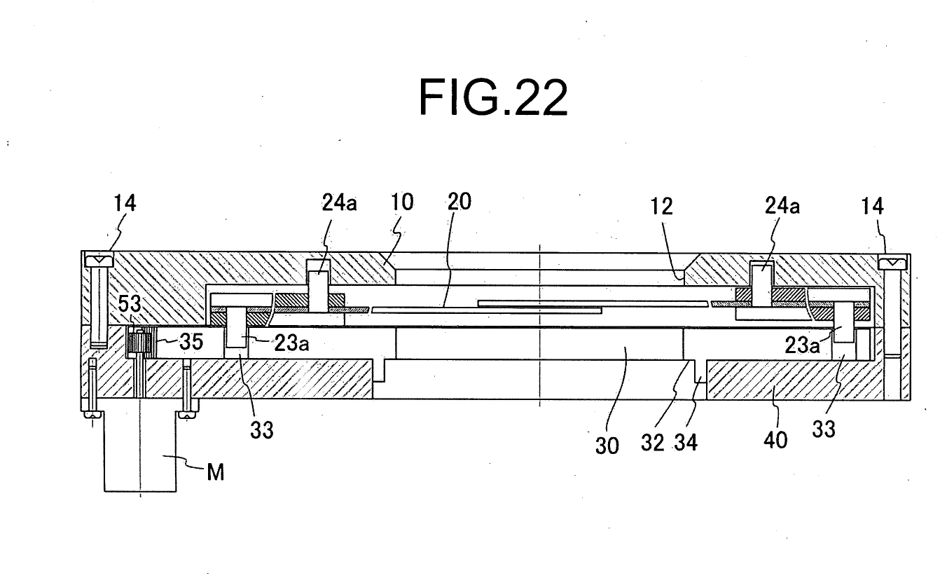

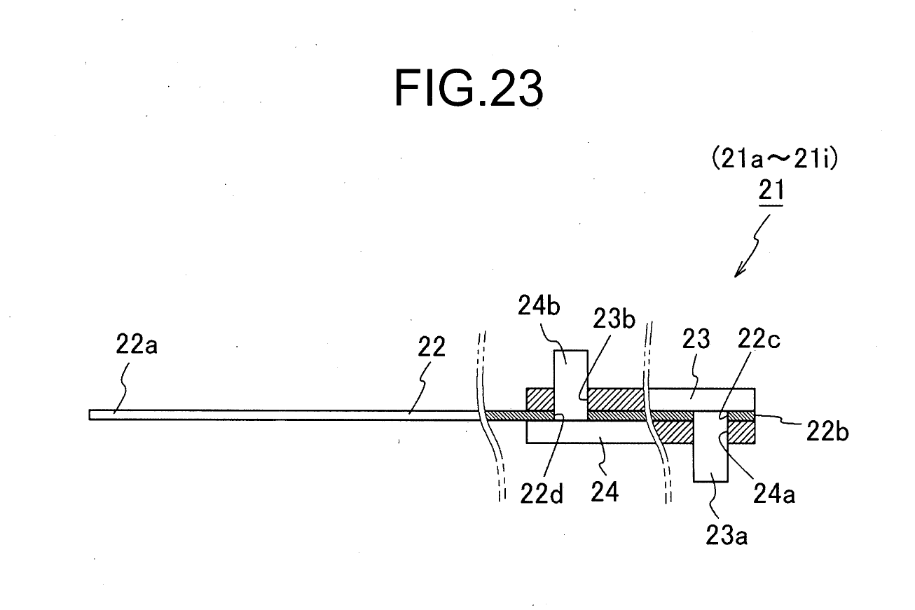

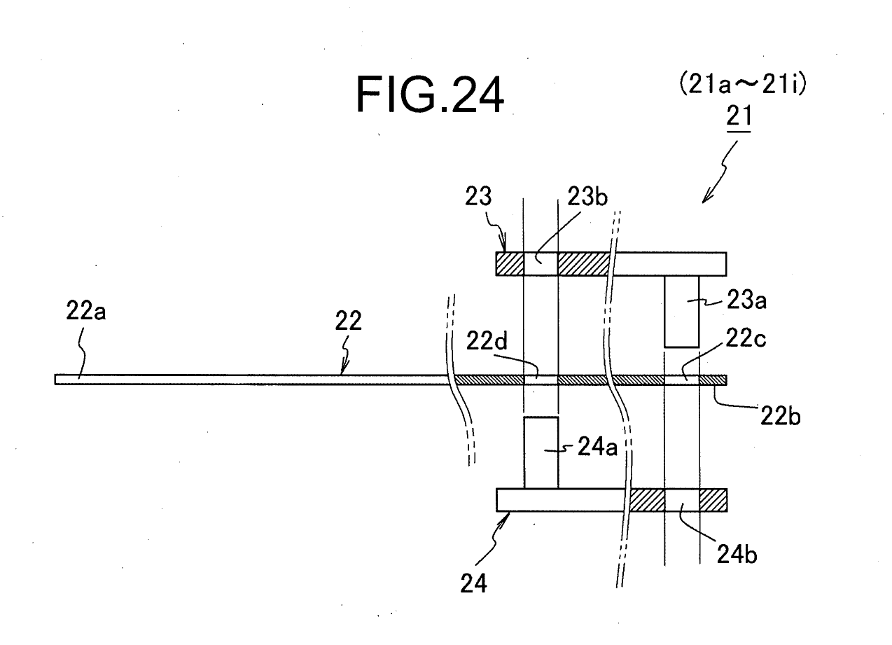

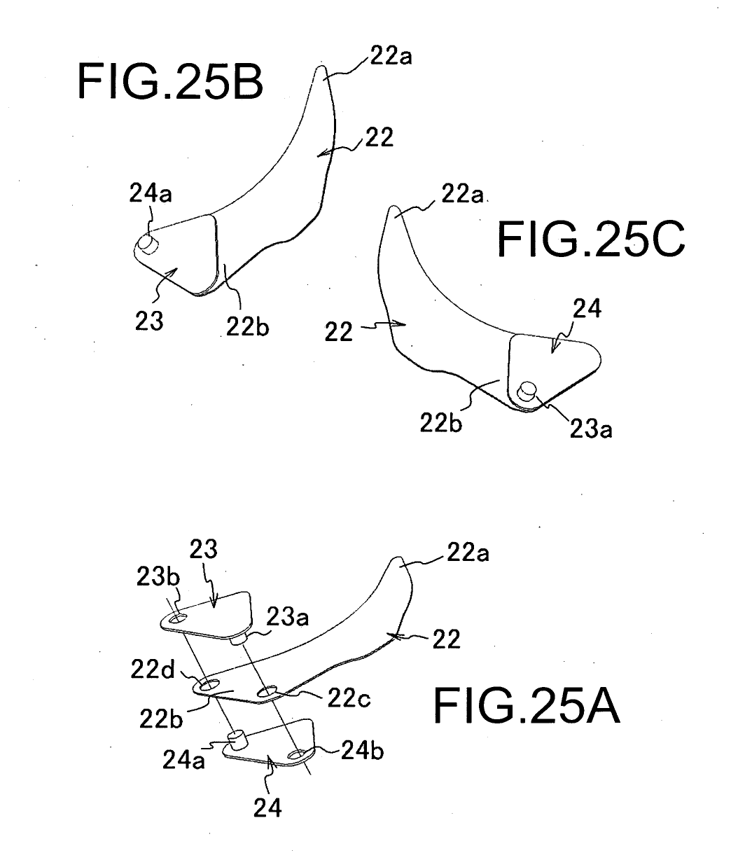

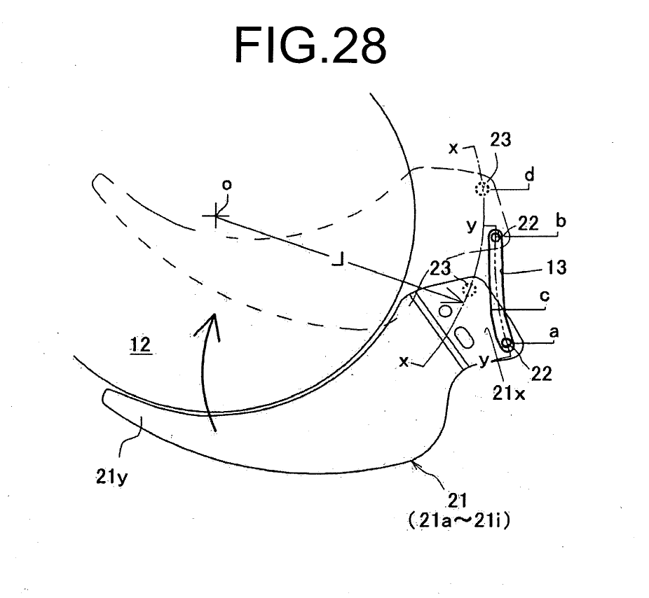

Each component will be described below based on FIGS. 20 to 28. FIG. 20A is a perspective explanatory view of the diaphragm blade set, FIG. 20B is a plan view of the second board (hold-down plate) viewed from the side of the diaphragm blade mount surface, FIG. 21A is a plan view of the first board viewed from the diaphragm blade set side, FIG. 21B is a perspective plan view of the first board (base plate), FIG. 22 is a sectional view to explain the arrangement relationship of each component in the assembly state of the apparatus of FIG. 19, FIG. 23 is a sectional view to explain a configuration of a single diaphragm blade constituting the diaphragm blade set as shown in FIG. 22, FIG. 24 is an exploded sectional view of a single diaphragm blade constituting FIG. 23, FIG. 25 is a perspective view of a single diaphragm blade of FIG. 23, and FIG. 28 is an explanatory view showing the open/close trajectory of the diaphragm blade in the apparatus of FIG. 19.

### [Configuration of the First Board]

The configuration of the first board 10 as shown in FIG. 21 will be described first. The first board 10 is generally called the base plate and is a member of an attachment reference of the apparatus.

The base plate 11 has the exposure aperture 12, and is configured in the shape in accordance with the barrel shape of an image pickup apparatus. The base plate 11 is made of metal, resin or the like and formed in material and dimensions for providing the apparatus with toughness. The base plate 11 shown in the figure is formed by mold forming of a synthetic resin with reinforcement fibers such as glass fibers mixed. The reason is to make the base plate 11 thin, compact and light weight.

The base plate 11 is provided with the exposure aperture 12 in the center portion, the blade support surface 11x (flat surface or a concavo-convex surface) that supports the diaphragm blades 21 is formed around the aperture, and in the support surface 11x are formed guide concave grooves 13 that guide (regulate motion of) diaphragm blades in the open/close direction. The configuration of the guide concave grooves 13 will be described later. “14” shown in the figure denotes the coupling protrusion that secures the hold-down plate 41, and a screw hole is formed inside the protrusion. In addition, the guide concave groove 13 is not a hole penetrating the board, and has the bottom formed to shield so that light does not leak from places except the guide surface that slidably guides a second shaft portion 24a of the diaphragm blade 21 and the exposure aperture 12, but may be a general penetrating guide groove in the conventional apparatus.

### [Configuration of the Diaphragm Blade Set]

The configuration of the diaphragm blade set 20 will be described next based on FIG. 8A. As shown in the figure, the diaphragm blade set 20 is comprised of a plurality of diaphragm blades 21 (21a to 21i). The diaphragm blades 21 shown in the figure are comprised of nine blades, and the shape of each blade is formed in the same shape. FIG. 9 shows the operation state of the diaphragm blades 21, and the base end portion 21x is supported by the above-mentioned base plate 11. Further, the blade portion 21y of the blade opens and closes the exposure aperture 12. At this point, the blade portions 21x of a plurality of blade members overlap one another in the shape of scales, reduce the exposure aperture 12 between the large diameter in FIG. 8A and the small diameter in FIG. 8B and adjust the quantity of light.

The diaphragm blades 21 (21a to 21i) will specifically be described based on FIGS. 22 to 25. First, as shown in FIG. 24, the diaphragm blade 21 is comprised of a blade substrate 22, auxiliary first substrate 23 and auxiliary second substrate 24. The blade substrate 22 is obtained by die-cutting, by pressing, a sheet material formed in the shape of a sheet by rolling processing of a resin material (polyester) with black pigments blended, in the shape of a blade comprised of a blade portion 22a constituting the blade portion 21y and a base end portion 22b constituting the base end portion 21x. In the base end portion 22b are formed a positioning hold 22c that a first shaft portion 23a of the auxiliary first substrate 23 penetrates, and a positioning hole 22d that a second shaft portion 24a of the auxiliary second substrate 24 penetrates. Meanwhile, the auxiliary first substrate 23 is formed in almost the same shape as the outside shape of the base end portion 22b with a resin material (polycarbonate), and in the substrate 23 are formed the first shaft portion 23a (operating pin) and a fit hole 23b that the second shaft portion 24a (guide pin) of the auxiliary second substrate 24 penetrates. Further, the auxiliary second substrate 24 is a reversed auxiliary first substrate 23, the same material can be used, and in the substrate 24 are formed the second shaft portion 24a (guide pin) and a fit hole 24b that the first shaft portion 23a (operating pin) of the auxiliary first substrate 23 penetrates.

Then, as shown in FIGS. 23 and 25, the first shaft portion 23a of the auxiliary first substrate 23 is inserted in the positioning hole 22c of the blade substrate 22, fitted into the fit hole 24b of the auxiliary second substrate 24 existing on the opposite side, and is projected to the side opposite to the blade substrate 22. At the same time, the second shaft portion 24a of the auxiliary second substrate 24 is inserted in the positioning hole 22d of the blade substrate 22, fitted into the fit hole 23b of the auxiliary first substrate 23 existing on the opposite side, and is projected to the side opposite to the blade substrate 22. In this way, the blade substrate 22 is sandwiched and supported by the first shaft portion 23a of the auxiliary first substrate 23 and the second shaft portion 24a of the auxiliary second substrate 24 in mutually opposite directions, and the blade substrate 22, auxiliary first substrate 23 and auxiliary second substrate 24 are thereby integrated and constitute a single diaphragm blade 21.

In addition, by further sandwiching and supporting the blade substrate 22, which is thus sandwiched and supported by the auxiliary first substrate 23 and the auxiliary second substrate 24, by the first board 10 and second board 30 as shown in FIG. 22, the first shaft portion 23a of the auxiliary first substrate 23 and the second shaft portion 24a of the auxiliary second substrate 24 are not detached from the positioning holes 22c and 22d of the blade substrate 22, respectively, the need for welding or bonding the auxiliary first substrate 23 and auxiliary second substrate 24 to the blade substrate 22 is eliminated unlike the conventional apparatus, and it does not happen that events of the malfunction and inoperative arise.

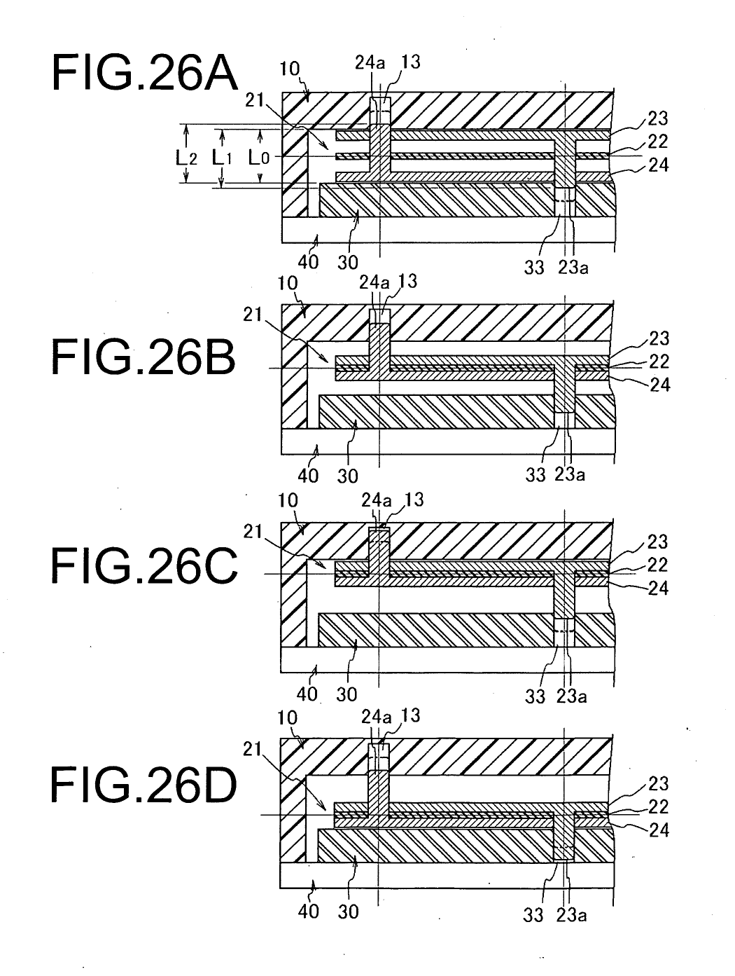

This will further be described specifically based on FIG. 26. FIG. 26 contains schematic views to explain the support state of a single diaphragm blade in FIG. 22, FIG. 26A shows a state in which each of the auxiliary first substrate 23 and auxiliary second substrate 24 fitted into the blade substrate 22 separates from the blade substrate 22 due to vibration or impact in a single integrated diaphragm blade 21, FIG. 26B shows a state in which a single integrated diaphragm blade 21 is in a beforehand set reference position, FIG. 26C shows a state in which a single integrated diaphragm blade 21 is shifted to the first board (base plate) 10 side by undergoing the effect of the apparatus attitude, and FIG. 26D shows a state in which a single integrated diaphragm blade 21 is shifted to the second board (driving pin) 30 side by undergoing the effect of the apparatus attitude. In any of the states of FIGS. 26A to 26D, as shown in the figures, the first shaft portion 23a of the auxiliary first substrate 23 is not detached from the shaft hole 33 of the second board (driving ring) 30, and similarly, the second shaft portion 24a of the auxiliary second substrate 24 is not detached from the guide concave groove 13 of the first board (base plate) 10 either. Accordingly, the blade substrate 22 fit-supported by the first shaft portion 23a of the auxiliary first substrate 23 and the second shaft portion 24a of the auxiliary second substrate 24 is always supported by the first board (base plate) 10 and the second board (driving ring) 30 with reliability in any of the states of FIGS. 26A to 26D, and as a result, it does not happen that events of the malfunction and inoperative arise.

To maintain such a state, as shown in FIG. 26A, with respect to a predetermined distance L0 between the first board (base plate) 10 and second board (driving ring) 30, the shaft length L1 of the first shaft portion 23a of the auxiliary first substrate 23 and the shaft length L2 of the second shaft portion 24a of the auxiliary second substrate 24 are beforehand set at lengths without being detached from the shaft hole 33 of the second board (driving ring) 30 and the guide concave groove 13 of the first board (base plate) 10 in any of the states of FIGS. 26A to 26D.

### Another Embodiment

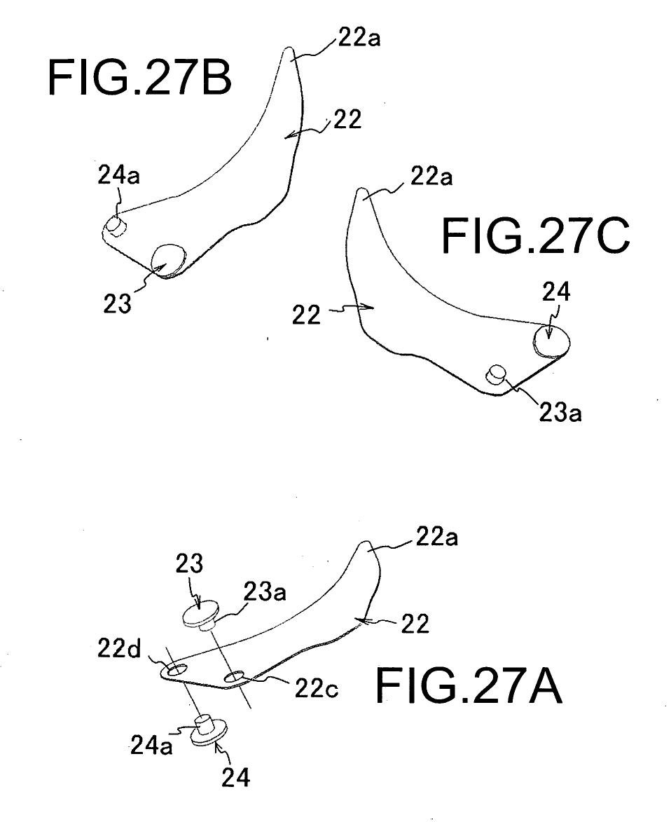

Further, as shown in FIG. 27, the first shaft portion 23a of the auxiliary first substrate 23 is inserted and fitted into the positioning hole 22c of the blade substrate 22, and is projected to the side opposite to the blade substrate 22. At the same time, the second shaft portion 24a of the auxiliary second substrate 24 is inserted and fitted into the positioning hole 22d of the blade substrate 22, and is projected to the side opposite to the blade substrate 22. In this way, the blade substrate 22 is sandwiched and supported by the first shaft portion 23a of the auxiliary first substrate 23 and the second shaft portion 24a of the auxiliary second substrate 24 in mutually opposite directions, the blade substrate 22, auxiliary first substrate 23 and auxiliary second substrate 24 are thereby integrated, and it is possible to thus constitute a single diaphragm blade 21. In addition, each of the auxiliary first substrate 23 and auxiliary second substrate 24 is supported to be rotatably with respect to the blade substrate 22, is thus different from the above-mentioned Embodiment, and needs to be formed in the shape for not affecting the others when the auxiliary substrate rotates.

### [Configuration of the Second Board]

The configuration of the second board 30 will be described next based on FIG. 20B. The second board 30 is generally called the driving ring, and is made of a member for receiving driving of the driving unit M and driving the diaphragm blades 21 (21a to 21i) to open and close as appropriate, and as shown in FIGS. 19 and 22, the driving ring 31 is attached rotatably to the hold-down plate 41.

As shown in the figure, the driving ring 31 forms the shape of a ring having the exposure aperture 12 in the center portion, for example, by mold forming using a resin, and the fringe 32 and engagement protrusion 34 are formed around the exposure aperture 12. The fringe 32 is fitted into the aperture 43 of the hold-down plate 41 and rotates about the center coinciding with the center of the exposure aperture 12.

Further, the driving ring 31 is incorporated into the hold-down plate 41 to be rotatable as described above, and passive teeth 35 are formed in part of the circumference. The passive teeth 35 are provided in a position to mesh with the driving gear 53 of the driving unit M, described later, attached to the mount 46 of the hold-down plate 41.

Furthermore, in the driving ring 31, the fit hole 33 that is fitted into the first shaft portion 23a (operating pin) of the auxiliary first board 23 planted in each of the diaphragm blades 21a to 21i is provided around the exposure aperture 12. The fit hole 33 is disposed in a plurality of portions (in the figure, nine portions) around the exposure aperture 12 corresponding to the number of diaphragm blades 21.

In such a configuration, the driving ring 31 is supported by the hold-down plate 41 rotatably, and rotates a predetermined angle by the driving gear 53 of the driving unit M. Then, rotation of the driving ring 31 is conveyed to each of the blade members 21a to 21i.

In addition, the configuration of the driving unit, the assembly process of the light quantity adjustment apparatus A, open/close action of the diaphragm blades and an image pickup apparatus using the light quantity, adjustment apparatus A are described previously, and therefore, the descriptions are omitted.

This application claims priority from Japanese Patent Application No. 2011-018513 filed on Jan. 31, 2011 and Japanese Patent Application No. 2011-041831 filed on Feb. 28, 2011.

1. A light quantity adjustment apparatus comprising: a pair of first and second boards each having an exposure aperture; and
a plurality of diaphragm blades supported between the pair of broads to be openable and closable to adjust a quantity of light passing through the exposure aperture,
wherein each of the diaphragm blades is comprised of a blade substrate in which are formed a base end portion positioned outside the exposure aperture, and a blade portion that moves forward and backward with respect to the exposure aperture to form a diaphragm aperture, and an auxiliary substrate, having a joint surface to be joined to the base end portion, in which are formed a first shaft portion penetrating the base end portion from the joint surface, and a second shaft portion provided to stand on the side opposite to the joint surface.

2. A light quantity adjustment apparatus comprising:
a pair of first and second boards each having an exposure aperture; and
a plurality of diaphragm blades which are supported between the pair of broads to be openable and closable, are sequentially overlapped at predetermined intervals around the exposure aperture to form a diaphragm, and adjust a quantity of light passing through the exposure aperture,
wherein each of the diaphragm blades is comprised of a blade substrate in which are formed a base end portion positioned outside the exposure aperture, and a blade portion that moves forward and backward with respect to the exposure aperture and that is curved in forming a diaphragm aperture, and an auxiliary substrate, having a joint surface to be joined to the base end portion, in which are formed a first shaft portion penetrating the base end portion from the joint surface, and a second shaft portion provided to stand on the side opposite to the joint surface, and
the auxiliary substrate is bonded to the base end portion.

3. A light quantity adjustment apparatus comprising:
a pair of first and second boards each having an exposure aperture; and
a plurality of diaphragm blades between the pair of boards to adjust a quantity of light passing through the exposure aperture,
wherein the plurality of diaphragm blades is successively piled and arranged at equal intervals around the exposure aperture on one board of the pair of boards in which among three mutually adjacent blades one blade adjacent to a center blade is positioned on the lower side and the other adjacent blade is positioned on the upper side,
each of the diaphragm blades is comprised of a blade substrate in which are formed a base end portion positioned outside the exposure aperture, and a blade portion that moves forward and backward with respect to the exposure aperture to form a diaphragm aperture, and an auxiliary substrate, having a joint surface to be joined to the base end portion, in which are formed a first shaft portion penetrating the base end portion from the joint surface, and a second shaft portion provided to stand on the side opposite to the joint surface,
the auxiliary substrate is disposed in the blade substrate on the side opposed to the other board of the pair of boards,
one board of the pair of boards is a driving ring that opens and closes the plurality of diaphragm blades,
a shaft hole that supports the first shaft portion of the auxiliary substrate is formed in the driving ring,
the other board of the pair of boards is a base plate to set the exposure aperture that is a full aperture, and
a slit groove that guides the second shaft portion of the auxiliary substrate is formed in the base plate.

4. A light quantity adjustment apparatus comprising:
a pair of boards each having an exposure aperture opposed to each other at a predetermined distance; and
a plurality of diaphragm blades supported between the pair of boards to be openable and closable to adjust a quantity of light passing through the exposure aperture,
wherein each of the diaphragm blades is comprised of a blade substrate comprised of a base end portion, positioned outside the exposure aperture, in which are formed at least two, first and second through holes, and a blade portion that moves forward and backward with respect to the exposure aperture to form a diaphragm aperture, and first and second auxiliary substrates to sandwich the base end portion of the blade substrate,
the first auxiliary substrate has a first shaft portion, penetrating the first through hole of the base end portion, supported on one of the pair of boards,
the second auxiliary substrate has a second shaft portion, penetrating the second through hole of the base end portion, supported on the other one of the pair of boards, and
shaft lengths of the first shaft portion and the second shaft portion are set to be longer than the distance between the pair of boards.

5. A light quantity adjustment apparatus comprising:
a pair of boards each having an exposure aperture opposed to each other at a predetermined distance; and
a plurality of diaphragm blades supported between the pair of boards to be openable and closable to adjust a quantity of light passing through the exposure aperture,
wherein each of the diaphragm blades is comprised of a blade substrate comprised of a base end portion, positioned outside the exposure aperture, in which are formed at least two, first and second through holes, and a blade portion that moves forward and backward with respect to the exposure aperture to form a diaphragm aperture, and first and second auxiliary substrates to sandwich the base end portion of the blade substrate,
the first auxiliary substrate has a first shaft portion, penetrating the first through hole of the base end portion, supported on one of the pair of boards, and a first shaft hole such that a second shaft portion of the second auxiliary substrate penetrates the second through hole of the base end portion,
the second auxiliary substrate has the second shaft portion, penetrating the second through hole of the base end portion, supported on the other one of the pair of boards, and a second shaft hole such that the first shaft portion of the first auxiliary substrate penetrates the first through hole of the base end portion, and
shaft lengths of the first shaft portion and the second shaft portion are set to be longer than the distance between the pair of boards.

6. The light quantity adjustment apparatus according to claim 1, wherein the plurality of diaphragm blades is successively piled and arranged at equal intervals around the exposure aperture on one board of the pair of boards in which among three mutually adjacent blades one blade adjacent to a center blade is positioned on the lower side and the other adjacent blade is positioned on the upper side, and
in each of the diaphragm blades, the auxiliary substrate is disposed in the blade substrate on the side opposed to the other board of the pair of boards.

7. The light quantity adjustment apparatus according to claim 6, wherein one board of the pair of boards is a driving ring that opens and closes the plurality of diaphragm blades, a shaft hole that supports the first shaft portion of the auxiliary substrate is formed in the driving ring,
the other board of the pair of boards is a base plate to set the exposure aperture that is a full aperture, and a slit groove that guides the second shaft portion of the auxiliary substrate is formed in the base plate.

8. A lens unit comprising:
a taking lens; and
a light quantity adjustment apparatus that adjusts a quantity of light passing through the taking lens,
wherein the light quantity adjustment apparatus is provided with the light quantity adjustment apparatus according to any one of claims 1 to 5.

9. An optical apparatus comprising:
a lens unit having a taking lens, and a light quantity adjustment apparatus that adjusts a quantity of light passing through the taking lens; and
light receiving means for receiving light of the quantity of light that is adjusted by the light quantity adjustment apparatus and that passes through the taking lens,
wherein the lens unit is the lens unit according to claim 8.
